(19) United States
(12) Patent Application Publication
(10) Pub. No.: US 2018/0171152 A1
(43) Pub. Date: Jun. 21, 2018

(54) METHOD FOR THE PREPARATION OF A COATING

(71) Applicant: ÉCOLE POLYTECHNIQUE FÉDÉRALE DE LAUSANNE (EPFL) EPFL-TTO, Lausanne (CH)

(72) Inventors: Holger FRAUENRATH, Lausanne (CH); Stephen SCHRETTL, Lausanne (CH); Bjoern SCHULTE, Morges (CH); Yves LETERRIER, Lausanne (CH)

(21) Appl. No.: 15/574,949

(22) PCT Filed: May 25, 2016
(86) PCT No.: PCT/EP2016/061828

§ 371 Date: Nov. 17, 2017

(30) Foreign Application Priority Data
May 27, 2015 (EP) PCT/EP2015/061763

(51) Int. Cl. C09D 4/00; C09D 5/08; B05D 1/02; B05D 1/18; B05D 1/28; B05D 3/06

(52) U.S. Cl. CPC C09D 4/00; C09D 5/08; B05D 3/067; B05D 1/18; B05D 1/28; B05D 1/02

(57) ABSTRACT

The invention relates to a method for the preparation of a coating comprising at least one coating layer on a solid substrate, said method comprising the steps of a, providing monomers of the type R—(N)ₓ-(L)ₘ-(C≡C)ₙ-(L′]ₒ(N′)_{y}—R′, wherein R is a head moiety, R′ is a tail moiety, (C≡C)ₙ is an oligoyne moiety, L and L′ are linker moieties, N and N′ independently are branched or unbranched optionally substituted C₁-C₂₅ alkyl moieties optionally containing 1 to 5 heteroatoms, x, m, o, and y are independently 0 or 1, n is 4 to 12, and wherein said head moiety allows for an interaction with the surface of said solid substrate; b. bringing said monomers into contact with said solid substrate wherein said interaction of said head moieties of said monomers with the surface of said solid substrate induces at least a part of said monomers to align in a defined manner thereby forming a film on said surface and bringing said oligoyne moieties of said monomers into close contact with each other; c. inducing a reaction between oligoyne moieties by providing an external stimulus so as to at least partially cross-link said aligned monomers, thereby forming a coating layer on said solid substrate. The invention further relates to a coating obtainable according to the method of the invention, the use of a coating obtainable according to the method of the invention, a solid substrate comprising a coating obtainable according to the invention and the use of the solid substrate.

### BACKGROUND OF THE INVENTION

The invention relates to a method for the preparation of a coating comprising at least one coating layer. The invention further relates to a coating obtainable according to the method according to the invention. Moreover, the invention relates to the use of a coating according to the invention. The invention also relates to a solid substrate comprising a coating according to the invention. In addition, the invention relates to the use of a solid substrate comprising a coating according to the invention.

Coatings are important in technological applications in which a material needs to be protected from compounds in its environment that are detrimental for its structural integrity or function, or where the material protects another product from such compounds. Barrier layers such as diffusion barrier layers are important components that help to confine gases in a defined compartment. Barrier layers may also comprise a coating. The use of sub-micrometer and micrometer-thick coatings and/or barrier layers has been technically implemented for decades. However, their use may adversely affect the properties of the materials, for example their optical properties. Furthermore, it is economically sensible to reduce the thickness of a coating in order to ensure that as little material as necessary is used while a good result is still achieved. Coatings with a thickness in the nanometer range represent the maximum reduction in thickness possible for a coating or a barrier layer. For thin coatings or barrier layers, it is particularly desirable to prepare coatings or barrier layers that have as few as possible defects. Ideally, these thin coatings or barrier layers are atomically dense, that is they have substantially no defect sites. The smaller the number of defect sites in a coating or a barrier layer, the more effective is the coating or barrier layer at preventing diffusion, gas permeation and/or corrosion. Moreover, coatings and/or barrier layers may add additional functional properties to the bulk material, for example, to modify the surface polarity and/or to give it the ability to change its properties under changed environmental conditions.

Coatings and/or barrier layers are important in packaging materials and/or materials for encapsulation. Materials with good diffusion barrier properties are essential for the protection and packaging of products and devices, for example, in the food industry, the pharmaceutical industry, and the electronics industry (for example, for the packaging of light emitting diodes in display technology or solar cells in photovoltaics). Moreover, coatings and/or barrier layers that provide reduced gas permeation at a low weight are relevant for sustainable solutions in the mobility sector, for example, by allowing for the fabrication of energy-saving tires. Typical coatings and/or barrier layers need to be inexpensive, particularly for the food, pharmaceutics, tubing, and photovoltaic application domains. Moreover, coatings and/or barrier layers should be easily processable. Further, coatings and/or barrier layers should ideally be also at least partially recyclable. For numerous food packaging solutions, an established approach is the use of polymers as barrier layers, such as poly(ethylene terephthalate) (PET) or poly(propylene) (PP) that already show a low enough intrinsic gas permeability with oxygen transmission rates (OTR) of 10 to 100 cm³ m⁻² d⁻¹ bar⁻¹ and/or water vapor transmission rates (WVTR) of 10 to 100 g m² d⁻¹. To improve the barrier properties to withstand a broad variety of chemical compounds, the polymer can be laminated with other polymers. Alternatively, a thin metal layer (for example, aluminum) or an inorganic layer such as silica may be applied to improve the barrier properties. Various processes like physical vapor deposition, (plasma-enhanced) chemical vapor deposition, or atomic layer deposition are technically established for the application of such metal or inorganic layers. The choice of the process depends on the composition of the coating, its desired thickness and/or the necessity to strictly control uniformity (Chatham, Surf Coat. Technol. 1996, 78, 1; Wyser, Packag. Technol. Sci. 2003, 16, 149). By applying such a metal or an inorganic layer, the resulting OTR can be decreased by a factor of approximately 10 to 100. The aforementioned approaches, however, pose problems with respect to the mechanical integrity of the brittle coatings. These problems result in substantially higher overall cost. Additionally, there are toxicological and environmental concerns with regard to these coatings (Duncan, J. Colloid Interf. Sci. 2011, 363, 1). The use of single-crystalline, defect-free graphene coating on a polymer surface can be used to realize materials with good barrier properties. Graphene is impermeable to gas molecules (McEuen, P. L. Nano Lett. 2008, 8, 2458), and graphene nanolayers were successfully used to prevent the oxidation of metals (Nilson, ACS Nano 2012, 6, 10258; Chen, ACS Nano 2011, 5, 1321). However, large-scale production and processing of graphene is difficult and incompatible to existing film processing techniques. Therefore, the chemical reduction of graphene oxide has been explored as an alternative. In this respect, flexible barrier layers based on laminates formed from reduced graphene oxide on PET (Geim, Nair, Nat. Commun. 2014, 5, 4843) were formed that show a moisture permeation of up to 10⁻² g m⁻² per day that significantly exceeds the barrier properties of commercially available metallized PET (with rates of 0.5 g m⁻²/day).

Barrier layers based on nanocomposites in which nanoparticles are embedded as filler into a matrix polymer, allow to address some of the abovementioned shortcomings. The nanoparticles are supposed to be impenetrable for gas molecules, resulting in a hindered diffusion of volatile compounds through the material. Enhanced barrier properties are achieved, in particular, if the nanoparticle fillers have a high aspect ratio (Grunlan, Nano Lett. 2010, 10, 4970). Typical filler materials are clays and silica nanoparticles (Choudalakis, European Polym. J. 2009, 45, 967; Shen, Chem. Rev. 2008, 108, 3893). Recent progress shows that the alignment of clay platelets in such composites leads to improved barrier properties (Hagen, RSC Adv. 2014, 4, 18354).

High aspect ratio nanostructures, such as graphene, graphene oxide (Geim, A. K., Science 2012, 335, 442), or reduced graphene oxide have also been used as filler materials (Park, J. App. Polym. Sci. 2014, DOI 10.1002/APP.39628). In particular, nanosheets of reduced graphene oxide (rGO) are interesting, since they possess a high aspect ratio and are well-dispersable due to the presence of chemical functional groups. However, the barrier properties of nanocomposites that employ rGO as a high aspect ratio filler are inferior to nanocomposites using the established clay particles.

In order to ensure the performance and lifetime of the corresponding devices, a sufficient protection of the active layers of organic electronic devices through an encapsulation with a material that provides improved barrier properties against, for example, oxygen and moisture, and other gases and volatile compounds is required (Logothetidis, Handbook of Flexible Organic Electronics, 2014, Woodhead Publishing). However, the development of suitable encapsulation materials remains a major challenge.

Recently, ultrahigh-perfomance barrier layers based on multilayered organic-inorganic structures have been developed for the encapsulation of optoelectronic and microelectronic devices such as light emitting diodes and photovoltaic devices (Letterier, Prog. Mater. Sci. 2003, 48, 1; Dhoble, Renew. Sus. Energ. Rev. 2015, 44, 319). For example, poly(ethylene naphtalate) (PEN) was used in combination with aluminum nitride and UV curable resins to prepare multilayered laminates that encapsulate organic light emitting diodes (OLED). The brittle nature of the inorganic layers, however, led to a deterioration of the WVTR values from 0.008 g m⁻² d⁻¹ to 0.02 g m⁻² d⁻¹ upon the application of mechanical stress (Park, Synth. Met. 2014, 193, 77). Many similar combinations of multilayered organic-inorganic structures have been investigated; however, materials with significantly lower OTR and WVTR values of below 10⁻⁶ cm³ m⁻² d⁻¹ bar⁻¹ and 10⁻⁶ g m⁻² d⁻¹, respectively, as required for the encapsulation of organic light emitting diodes, have not yet been identified (Lewis, Mater. Today, 2006, 9, 38; Burrows, Displays, 2001, 22, 65). While multilayered organic-inorganic composites with sufficient barrier performance have been suggested, the encapsulation of devices while simultaneously ensuring a sufficient transparency, solvent resistance, and/or ease of processability remains a challenge.

Anticorrosive coatings are another important technical field. The purpose of an anticorrosive coating is to protect the coated material from compounds or physical processes in its environment that would adversely affect the material's structural integrity and/or function. In order to protect materials against corrosion, several approaches are feasible: (i) the use of a sacrificial coating that is subject to corrosion before the bulk material, (ii) the use of a metal that forms a passivating surface layer, (iii) or the obstruction of diffusion of oxygen, water, or ions through a barrier coating that encapsulates the substrate or covers the surface (Weinell, C. E. J. Coat. Technol. Res. 2009, 6, 135). The latter aspect is especially relevant to counteract pitting and crevice corrosion (Gupta, Corrosion Science 2015, 92, 1; Smyrl, ECS Transactions 2008, 16, 39). In both cases, local galvanic corrosion occurs on the nano- or micrometer scale, leading to deterioration of the material.

In general, anticorrosive coatings can be individually designed to withstand the conditions in the specific environment in which the respective substrate is located. Typically, the employed coatings are multilayer systems, encompassing a primer to secure adhesion to the substrate, an intermediate coating to prevent diffusion to the material's surface, and a top coating to impart the desired surface properties (Kjernsmo, D.; Corrosion Protection. Bording A/S, Copenhagen, 2003). The overall thorough and dense coverage of the clean substrate surface is crucial to prevent diffusion through the coating, which would result in underfilm corrosion (Mayne, J. Oil. Color Chem. Assoc. 1975, 58, 155), blistering, or delamination (Elsner, CI Prog. Org. Coat. 2003, 48, 50.). Adhesion to the substrate is achieved either mechanically through penetration of the coating into surface pits, chemically through covalent bonds, or physically through secondary interactions such as van-der-Waals interactions or hydrogen bonding. Inorganic coatings are typically employed to improve the adhesion to the surface of the substrate, but organic coatings would have the advantage that they are mechanically more flexible and less prone to cracking.

Typical examples of organic anticorrosive coatings are epoxy resins, alkyd resins, as well as cross-linked poly(siloxane)s or polyurethanes that are applied as monomers but form a chemically resistant coating after polymerization and cross-linking. Multilayer coatings are used to complement the properties of different coating materials. For example, epoxies are known to show good adhesion properties due to facile reaction with functional groups on the surface of the substrate, but are easily susceptible to UV damage. As another example, polyurethanes may easily fulfill the desired gloss requirements, but delaminate from metal surfaces. Therefore, they are only used as top coatings (Weiss, K. D. Prog. Polym. Sci. 1997, 22, 203.).

Promising recent approaches to combine the functions of the primer and the intermediate coating have made use of organophosphonates that are known to adhere well to metal surfaces and show a low sensitivity to hydrolysis (To, Corros. Sci. 1997, 39, 1925). For example, poly(sulfone)s equipped with phosphonate side groups have been employed as anticorrosive layers and shown enhanced protection of a steel surface against corrosion (Chauveau, J. Appl. Polym. Sci. 2015, DOI: 10.1002/APP.41890). Along similar lines, a hydrophilic adhesion promoter has been reported based on a poly(glycidol) with phosphonate and acrylate side groups (Koehler, J. J. Mater. Chem. B. 2015, 3, 804), allowing for UV curing after adsorption to a metal surface. Moreover, bifunctional monomers equipped with a phosphonate group for surface attachment and a pyrrol or a thiophene group resulted in polymeric coatings with thicknesses above 50 nm that showed improved performance in delamination tests (Jaehne, Prog. Org. Coat. 2008, 61, 211).

The processes from the prior art have in common that for the preparation of thin coatings, materials that are difficult to handle such as graphene are required, or that multilayer coatings comprising several layers from different materials are required. A further disadvantage of some of the prior art approaches is the fact that composite materials in which nanoparticles are imbedded inside a matrix are required the preparation of which is costly. A solution-phase approach would be desirable for this purpose.

As a step in this direction, Olesik and Ding prepared carbon nanospheres in a wet-chemical approach by carbonization of a dispersion of deca-2,4,6,8-tetrayne-1,10-diol as the molecular precursor in a THF/water mixture (Olesik, Nano Lett. 2004, 4, 2271; Olesik, Chem. Mater. 2005, 17, 2353; Olesik, Chemical Synthesis of Polymeric Nanomaterials and Carbon Nanomaterials, 2006, US 2006/0223947 A1). The carbonization was carried out by heating the mixture to 70° C., and the addition of surfactants efficiently helped to control the size of the obtained water-soluble carbon nanospheres.

Zhao and coworkers conducted a solid-state polymerization of different fullerene-substituted tetrayne derivatives (Zhao, J. Am. Chem. Soc. 2005, 127, 14154; Zhao, J. Org. Chem. 2010, 75, 1498). Films of the molecular precursors were prepared by drop-casting or spin-coating of toluene solutions on a mica surface, and their reaction was induced by thermal treatment at a temperature of 160° C. One of the investigated tetrayne derivatives gave rise to homogeneously distributed carbon nanospheres with a uniform diameter below 20 nm after the thermal treatment.

Frauenrath and coworkers prepared oligoyne amphiphiles, that is, molecules comprising a segment (—C≡C—)ₙ with alternating carbon-carbon triple and single bonds, as well as a hydrophilic head group (Schrettl, Chem. Sci. 2015, 6, 564). Amphiphilic glycosylated hexayne amphiphiles were prepared in this way to self-assemble into vesicles in aqueous dispersions that gave rise to carbon nanocapsules upon UV irradiation below room temperature (Szilluweit, Nano Lett. 2012, 12, 2573). Similarly, carbon nanosheets on water were prepared by UV irradiation at room temperature, starting from a self-assembled monolayer of a hexayne-containing methyl carboxylate amphiphile self-assembled at the air-water interface (Schrettl, Nature. Chem. 2014, 6, 468).

However, none of these approaches using reactive molecular precursors yielded a thin coating on a solid substrate, in particular, they did not yield a thin coating on a solid substrate directly from molecular precursors on a solid substrate.

Starting from the prior art, an object of the invention is to provide a method for the preparation of a thin coating on a solid substrate that employs compounds and/or materials that are compatible with existing film processing techniques. A particular aspect of the invention is to provide a method for the preparation of a thin coating on a solid substrate that is based on a solution phase approach.

A further object of the invention is to provide a method for the preparation of a thin coating on a solid substrate that provides barrier properties and/or that allows to adjust the hydrophobicity of the sample.

A further object of the invention is to provide a method for the preparation of a thin coating on a solid substrate that comprises only a few coating layers.

A further object of the invention is to provide a method for the preparation of a thin coating on a solid substrate that is substantially free from defect sites.

A further object of the invention is to provide a method for the preparation of a thin coating on a solid substrate that employs reactive molecular precursors that undergo carbonization under mild conditions.

A further object of the invention is to provide a method for the preparation of a thin coating on a solid substrate that employs reactive molecular precursors that are equipped with a head group that allows for binding to the surface of the solid substrate. A particular object of the invention is to provide a method for the preparation of a thin coating on a solid substrate that provides good adhesion to the solid substrate.

A further object of the invention is to provide a method for the preparation of a thin coating on a solid substrate that has a defined density and/or nature of functional moieties on at least one of the sides of the coating.

### SUMMARY OF THE INVENTION

By employing the present invention, some or all of the difficulties and drawbacks found in the prior art can be overcome. In particular, some or all of the difficulties and drawbacks of the prior art can be overcome by the method of claim 1, the coating of claim 30, the use of claim 32, the solid substrate of claim 33, and the use of claim 34.

Further embodiments of the invention are described in the dependent claims and will be discussed in the following.

The invention provides for a method for the manufacture of a coating comprising at least one coating layer on a solid substrate, said method comprising the steps of

a. providing monomers of the type R—(N)ₓ-(L)ₘ-(C≡C)ₙ-(L′)ₒ-(N′)_{y}—R′, wherein
R is a head moiety,
R′ is a tail moiety,
(C≡C)ₙ is an oligoyne moiety,
L and L′ are linker moieties,
N and N′ independently are branched or unbranched optionally substituted C₁-C₂₅ alkyl moieties optionally containing 1 to 5 heteroatoms,
x, m, o, and y are independently 0 or 1,
n is 4 to 12,
and wherein the head moiety allows for an interaction with the surface of the solid substrate;
b. bringing the monomers into contact with the solid substrate wherein the interaction of the head moieties of the monomers with the surface of the solid substrate induces at least a part of the monomers to align in a defined manner thereby forming a film on the surface and bringing the oligoyne moieties of the monomers into close contact with each other;
c. inducing a reaction between oligoyne moieties by providing an external stimulus so as to at least partially cross-link the aligned monomers, thereby forming a coating layer on the solid substrate.

Preferably, N and N′ independently are branched or unbranched optionally substituted C₁-C₁₄ alkyl moieties optionally containing 1 to 5 heteroatoms. Examples for N and N′ may include C₁-C₁₂—OC(═O)—, C₁-C₁₂—NHC(═O)—, C₁-C₁₂—NHC(═O)O—, C₁-C₁₂—SC(═O)—, C₁-C₁₂—O—, C₁-C₁₂—NH—, C₁-C₁₂—S—, —OC(═O)—, —NHC(═O)—, —NHC(═O)O—, —(O═)S(═O)—O—, —(O═)S(═O)—O—CH₂—.

It has surprisingly been found that using the above method, a coating can be obtained that can overcome some or all of the drawbacks of the prior art mentioned above. In particular, the use of a head moiety that allows for an interaction with the surface of the solid substrate and induces at least part of the monomers to align in a defined manner thereby forming a film on the surface and bringing the oligoyne moieties of the monomers into close contact with each other appears to be helpful in overcoming the drawbacks of the prior art. Without wishing to be bound to a scientific theory, the surprising effect appears to be explainable by the fact that the close contact of the oligoyne moieties allows for an efficient at least partial cross-linking of the monomers. Moreover, the close contact of the oligoyne moieties with each other may also favor the formation of a layer that is substantially free from defect sites. A further advantage of the method according to the invention is that the surfaces to which the coatings are applied in the method according to the invention do not need to be atomically flat in order to achieve a dense surface coverage and a strong binding of the coating to the surface.

### Definitions

The following definitions shall apply throughout unless otherwise noted.

“Alkyl” means an aliphatic hydrocarbon moiety which may be straight or branched having about 1 to about 25 carbon atoms in the chain. Preferred alkyl moieties have 1 to about 20, more preferred 1 to about 14, carbon atoms in the chain. Branched means that one or more lower alkyl moieties such as methyl, ethyl or propyl are attached to a linear alkyl chain. “Lower alkyl” means about 1 to about 4 carbon atoms in the chain that may be straight or branched. “Substituted alkyl” means an alkyl moiety as defined above which is substituted with one or more “aliphatic moiety substituents” (preferably 1 to 3) which may be the same or different, and are as defined herein. Alkyl moieties may contain 1 to 5 heteroatoms as defined herein. Preferred heteroatoms for alkyl moieties are oxygen, nitrogen, and sulfur. Substituted alkyl moieties may contain 1 to 5 heteroatoms as defined herein. Preferred heteroatoms for substituted alkyl moieties are oxygen, nitrogen, and sulfur. In a substituted alkyl moiety, one or more heteroatoms may be adjacent to a chain atom bearing an aliphatic moiety substituent as defined herein. In an alkyl moiety, a heteroatom may bear an aliphatic moiety substituent as defined herein. Preferred substituted alkyl moieties are C₁-C₁₂—OC(═O)—, C₁-C₁₂—NHC(═O)—, C₁-C₁₂—NHC(═O)O—, C₁-C₁₂—SC(═O)—. Preferred alkyl moieties are C₁-C₁₂—O—, C₁-C₁₂—NH—, C₁-C₁₂—S—.

“Aliphatic” means alkyl, alkenyl or alkynyl as defined herein.

“Aliphatic moiety substituent(s)” mean substituents attached to an aliphatic moiety as defined herein inclusive of aryl, heteroaryl, hydroxy, alkoxy such as methoxy or ethoxy, cyclyloxy, aryloxy, heteroaryloxy, acyl or its thioxo analogue, cyclylcarbonyl or its thioxo analogue, aroyl or its thioxo analogue, heteroaroyl or its thioxo analogue, acyloxy, cyclylcarbonyloxy, aroyloxy, heteroaroyloxy, halo, nitro, cyano, carboxy (acid), —C(═O)—NHOH, —C(═O)—CH₂OH, —C(═O)—CH₂SH, —C(═O)—NH—CN, sulpho, phosphono, alkylsulphonylcarbamoyl, tetrazolyl, arylsulphonylcarbamoyl, N-methoxycarbamoyl, heteroarylsulphonylcarbamoyl, 3-hydroxy-3-cyclobutene-1,2-dione, 3,5-dioxo-1,2,4-oxadiazolidinyl or hydroxyheteroaryl such as 3-hydroxyisoxazolyl, 3-hydoxy-1-methylpyrazolyl, alkoxycarbonyl, cyclyloxycarbonyl, aryloxycarbonyl, heteroaryloxycarbonyl, alkylsulfonyl, cyclylsulfonyl, arylsulfonyl, heteroarylsulfonyl, alkylsulfinyl, cyclylsulfinyl, arylsulfinyl, heteroarylsulfinyl, alkylthio, cyclylthio, arylthio, heteroarylthio, cyclyl, aryldiazo, heteroaryldiazo, thiol, methylene (H₂C═), oxo (O═), thioxo (S═). Acidic/amide aliphatic moiety substituents are carboxy (acid), —C(═O)—NHOH, —C(═O)—CH₂OH, —C(═O)—CH₂SH, —C(═O)—NH—CN, sulpho, phosphono, alkylsulphonylcarbamoyl, tetrazolyl, arylsulphonylcarbamoyl, N-methoxycarbamoyl, heteroarylsulphonylcarbamoyl, 3-hydroxy-3-cyclobutene-1,2-dione, 3,5-dioxo-1,2,4-oxadiazolidinyl or hydroxyheteroaryl such as 3-hydroxyisoxazolyl, 3-hydoxy-1-methylpyrazolyl. Non-acidic polar aliphatic moiety substituents are hydroxy, oxo (O═), thioxo (S═), acyl or its thioxo analogue, cyclylcarbonyl or its thioxo analogue, aroyl or its thioxo analogue, heteroaroyl or its thioxo analogue, alkoxycarbonyl, cyclyloxycarbonyl, aryloxycarbonyl, heteroaryloxycarbonyl, acyloxy, cyclylcarbonyloxy, aroyloxy, heteroaroyloxy, alkylsulfonyl, cyclylsulfonyl, arylsulfonyl, heteroarylsulfonyl, alkylsulfinyl, cyclylsulfinyl, arylsulfinyl, heteroarylsulfinyl, thiol. Exemplary aliphatic moieties bearing an aliphatic moiety substituent include methoxymethoxy, methoxyethoxy, ethoxyethoxy, (methoxy-, benzyloxy-, phenoxy-, ethoxy-, or propyloxy-) carbonyl(methyl, ethyl, or propyl), (methoxy-, benzyloxy-, phenoxy-, ethoxy-, or propyloxy-)carbonyl, (methyl, ethyl, or propyl)aminocarbonyl(methyl, ethyl, or propyl), (methyl, ethyl, or propyl)aminocarbonyl, pyridylmethyloxy-carbonylmethyl, methoxyethyl, ethoxymethyl, n-butoxymethyl, cyclopentylmethyloxyethyl, phenoxypropyl, phenoxyallyl, trifluoromethyl, cyclopropyl-methyl, cyclopentylmethyl, carboxy(methyl or ethyl), 2-phenethenyl, benzyloxy, 1- or 2-naphthyl-methoxy, 4-pyridyl-methyloxy, benzyloxyethyl, 3-benzyloxyallyl, 4-pyridylmethyloxyethyl, 4-pyridylmethyl-oxyallyl, benzyl, 2-phenethyl, naphthylmethyl, styryl, 4-phenyl-1,3-pentadienyl, phenylpropynyl, 3-phenylbut-2-ynyl, pyrid-3-ylacetylenyl and quinolin-3-ylacetylenyl, 4-pyridyl-ethynyl, 4-pyridylvinyl, thienylethenyl, pyridylethenyl, imidazolylethenyl, pyrazinylethenyl, pyridylpentenyl, pyridylhexenyl and pyridylheptenyl, thienylmethyl, pyridylmethyl, imidazolylmethyl, pyrazinylmethyl, tetrahydropyranylmethyl, tetrahydropyranyl-methyloxymethyl, and the like. A preferred aliphatic moiety substituent is oxo (O═).

“Acyl” means an H—C(═O)— or (aliphatic or cyclyl)-C(═O)— moiety wherein the aliphatic moiety is as herein described. Preferred acyls contain a lower alkyl. Exemplary acyl moieties include formyl, acetyl, propanoyl, 2-methylpropanoyl, butanoyl, palmitoyl, acryloyl, propynoyl, cyclohexylcarbonyl, and the like.

“Acyloxy” means an H—C(═O)—O— or (aliphatic or cyclyl)-C(═O)—O moiety wherein the aliphatic moiety is as herein described. Preferred acyloxys contain a lower alkyl. Exemplary acyloxy moieties include acetoxy and propionyloxy, and the like.

“Alkenoyl” means an alkenyl-C(═O)— moiety wherein alkenyl is as defined herein.

“Alkenyl” means an aliphatic hydrocarbon moiety containing a carbon-carbon double bond and which may be straight or branched having about 2 to about 15 carbon atoms in the chain. Preferred alkenyl moieties have 2 to about 12 carbon atoms in the chain; and more preferably about 2 to about 4 carbon atoms in the chain. Branched means that one or more lower alkyl moieties such as methyl, ethyl or propyl are attached to a linear alkenyl chain. “Lower alkenyl” means about 2 to about 4 carbon atoms in the chain that may be straight or branched. Exemplary alkenyl moieties include ethenyl, propenyl, n-butenyl, i-butenyl, 3-methylbut-2-enyl, n-pentenyl, heptenyl, octenyl, cyclohexylbutenyl, decenyl, and the like. “Substituted alkenyl” means an alkenyl moiety as defined above which is substituted with one or more “aliphatic moiety substituents” (preferably 1 to 3) which may be the same or different and are as defined herein. Exemplary alkenyl alphatic moiety substituents include halo or cycloalkyl moieties. Alkenyl moieties may contain 1 to 5 heteroatoms as defined herein. Substituted alkenyl moieties may contain 1 to 5 heteroatoms as defined herein. In a substituted alkenyl moiety, one or more heteroatoms may be adjacent to a chain atom bearing an aliphatic moiety substituent as defined herein. In an alkenyl moiety, a heteroatom may bear an aliphatic moiety substituent as defined herein.

“Alkenyloxy” means an alkenyl-O— moiety wherein the alkenyl moiety is as herein described. Exemplary alkenyloxy moieties include allyloxy, 3-butenyloxy, and the like.

“Alkoxy” means an alkyl-O— moiety wherein the alkyl moiety is as herein described. Exemplary alkoxy moieties include methoxy, ethoxy, n-propoxy, i-propoxy, n-butoxy, heptoxy, and the like.

“Alkoxycarbonyl” means an alkyl-O—C(═O)— moiety, wherein the alkyl moiety is as herein defined. Exemplary alkoxycarbonyl moieties include methoxycarbonyl, ethoxycarbonyl, t-butyloxycarbonyl, and the like.

“Alkylsulfinyl” means an alkyl-SO— moiety wherein the alkyl moiety is as defined above. Preferred moieties are those wherein the alkyl moiety is lower alkyl.

“Alkylsulfonyl” means an alkyl-SO₂-moiety wherein the alkyl moiety is as defined above. Preferred moieties are those wherein the alkyl moiety is lower alkyl.

“Alkylsulphonylcarbamoyl” means an alkyl-SO₂—NH—C(═O)— moiety wherein the alkyl moiety is as herein described. Preferred alkylsulphonylcarbamoyl moieties are those wherein the alkyl moiety is lower alkyl.

“Alkylthio” means an alkyl-S— moiety wherein the alkyl moiety is as herein described. Exemplary alkylthio moieties include methylthio, ethylthio, i-propylthio and heptylthio.

“Alkynyl” means an aliphatic hydrocarbon moiety containing a carbon-carbon triple bond and which may be straight or branched having about 2 to about 15 carbon atoms in the chain. Preferred alkynyl moieties have 2 to about 12 carbon atoms in the chain; and more preferably about 2 to about 4 carbon atoms in the chain. Branched means that one or more lower alkyl moieties such as methyl, ethyl or propyl are attached to a linear alkynyl chain. “Lower alkynyl” means about 2 to about 4 carbon atoms in the chain that may be straight or branched. The alkynyl moiety may be substituted by one or more halo. Exemplary alkynyl moieties include ethynyl, propynyl, n-butynyl, 2-butynyl, 3-methylbutynyl, n-pentynyl, heptynyl, octynyl, decynyl, and the like.

“Substituted alkynyl” means alkynyl as defined above which is substituted with one or more “aliphatic moiety substituents” (preferably 1 to 3) which may be the same or different, and are as defined herein.

“Aromatic moiety” means aryl or heteroaryl as defined herein. Exemplary aromatic moieties include phenyl, halo substituted phenyl, azaheteroaryl, and the like.

“Aroyl” means an aryl-C(═O)— moiety wherein the aryl moiety is as herein described. Exemplary aroyl moieties include benzoyl, 1- and 2-naphthoyl, and the like.

“Aroyloxy” means an aryl-C(═O)—O— moiety wherein the aryl moiety is as herein described

“Aryl” means an aromatic monocyclic or multicyclic ring system of about 6 to about 14 carbon atoms, preferably of about 6 to about 10 carbon atoms. The aryl is optionally substituted with one or more “ring moiety substituents” which may be the same or different, and are as defined herein. Exemplary aryl moieties include phenyl or naphthyl, or phenyl substituted or naphthyl substituted. “Substituted aryl” means an aryl moiety as defined above which is substituted with one or more “ring moiety substituents” (preferably 1 to 3) which may be the same or different and are as defined herein.

“Aryloxy” means an aryl-O— moiety wherein the aryl moiety is as defined herein. Exemplary aryloxy moieties include phenoxy and 2-naphthyloxy.

“Aryloxycarbonyl” means an aryl-O—C(═O)— moiety wherein the aryl moiety is as defined herein. Exemplary aryloxycarbonyl moieties include phenoxycarbonyl and naphthoxycarbonyl.

“Arylsulfonyl” means an aryl-SO₂— moiety wherein the aryl moiety is as defined herein.

“Arylsulphonylcarbamoyl” means an aryl-SO₂—NH—C(═O)— moiety wherein the aryl moiety is as herein described. An exemplary arylsulphonylcarbamoyl moiety is phenylsulphonylcarbamoyl.

“Arylsulfinyl” means an aryl-SO— moiety wherein the aryl moiety is as defined herein.

“Arylthio” means an aryl-S— moiety wherein the aryl moiety is as herein described. Exemplary arylthio moieties include phenylthio and naphthylthio.

“Carboxy” means an HO(O═)C— (carboxylic acid) moiety.

“Cycloalkenyl” means a non-aromatic mono- or multicyclic ring system of about 3 to about 10 carbon atoms, preferably of about 5 to about 10 carbon atoms, and which contains at least one carbon-carbon double bond. Preferred ring sizes of rings of the ring system include about 5 to about 6 ring atoms; and such preferred ring sizes are also referred to as “lower”. “Substituted cycloalkenyl” means an cycloalkyenyl moiety as defined above which is substituted with one or more “ring moiety substituents” (preferably 1 to 3) which may be the same or different and are as defined herein. Exemplary monocyclic cycloalkenyl include cyclopentenyl, cyclohexenyl, cycloheptenyl, and the like. An exemplary multicyclic cycloalkenyl is norbornylenyl.

“Cycloalkyl” means a non-aromatic mono- or multicyclic ring system of about 3 to about 10 carbon atoms, preferably of about 5 to about 10 carbon atoms. Preferred ring sizes of rings of the ring system include about 5 to about 6 ring atoms; and such preferred ring sizes are also referred to as “lower”. “Substituted cycloalkyl” means a cycloalkyl moiety as defined above which is substituted with one or more “ring moiety substituents” (preferably 1 to 3) which may be the same or different and are as defined herein. Exemplary monocyclic cycloalkyl include cyclopentyl, cyclohexyl, cycloheptyl, and the like. Exemplary multicyclic cycloalkyl include 1-decalin, norbornyl, adamant-(1- or 2-)yl, and the like.

“Cyclic” or “Cyclyl” means cycloalkyl, cycloalkenyl, heterocyclyl or heterocyclenyl as defined herein. The term “lower” as used in connection with the term cyclic is the same as noted herein regarding the cycloalkyl, cycloalkenyl, heterocyclyl or heterocyclenyl.

“Cyclylcarbonyl” means a cyclyl-C(═O)— moiety wherein the cyclyl moiety is as defined herein.

“Cyclylcarbonyloxy” means a cyclyl-C(═O)—O— moiety wherein the cyclyl moiety is as defined herein.

“Cyclyloxy” means a cyclyl-O— moiety wherein the cyclyl moiety is as herein described. Exemplary cyclyloxy moieties include cyclopentyloxy, cyclohexyloxy, quinuclidyloxy, pentamethylenesulfideoxy, tetrahydropyranyloxy, tetrahydrothiophenyloxy, pyrrolidinyloxy, tetrahydrofuranyloxy or 7-oxabicyclo[2.2.1]heptanyloxy, hydroxytetrahydropyranyloxy, hydroxy-7-oxabicyclo[2.2.1]heptanyloxy, and the like.

“Cyclyloxycarbonyl” means a cyclyl-O—C(═O)— moiety wherein the cyclyl moiety is as herein described.

“Cyclylsulfinyl” means a cyclyl-S(O)— moiety wherein the cyclyl moiety is as herein described.

“Cyclylsulfonyl” means a cyclyl-S(O)₂— moiety wherein the cyclyl moiety is as herein described.

“Cyclylthio” means a cyclyl-S— moiety wherein the cyclyl moiety is as herein described.

“Diazo” means a bivalent —N═N— radical.

“Halo” means fluoro, chloro, bromo, or iodo. Preferred are fluoro, chloro or bromo.

“Heteroaroyl” means a heteroaryl-C(═O)— moiety wherein the heteroaryl moiety is as herein described. Exemplary heteroaroyl moieties include thiophenoyl, nicotinoyl, pyrrol-2-ylcarbonyl, 1- and 2-naphthoyl, pyridinoyl, and the like.

“Heteroaroyloxy” means a heteroaryl-C(═O)—O moiety wherein the heteroaryl moiety is as defined herein.

“Heteroaryl” means an aromatic monocyclic or multicyclic ring system of about 5 to about 14 carbon atoms, preferably about 5 to about 10 carbon atoms, in which one or more of the carbon atoms in the ring system is/are heteroatom(s) other than carbon, for example boron, nitrogen, oxygen, phosphorous, sulfur, silicon, or germanium. Preferably the ring system includes 1 to 3 heteroatoms. Preferred ring sizes of rings of the ring system include about 5 to about 6 ring atoms. “Substituted heteroaryl” means a heteroaryl moiety as defined above which is substituted with one or more “ring moiety substituents” (preferably 1 to 3) which may be the same or different and are as defined herein. The designation of the aza, oxa or thia as a prefix before heteroaryl define that at least a nitrogen, oxygen or sulfur atom is present, respectively, as a ring atom. A nitrogen atom of a heteroaryl may be a basic nitrogen atom and may also be optionally oxidized to the corresponding N-oxide. Exemplary heteroaryl and substituted heteroaryl moieties include pyrazinyl, thienyl, isothiazolyl, oxazolyl, pyrazolyl, furazanyl, pyrrolyl, 1,2,4-thiadiazolyl, pyridazinyl, quinoxalinyl, phthalazinyl, imidazo[1,2-a]pyridine, imidazo[2,1-b]thiazolyl, benzofurazanyl, azaindolyl, benzimidazolyl, benzothienyl, thienopyridyl, thienopyrimidyl, pyrrolopyridyl, imidazopyridyl, benzoazaindolyl, 1,2,4-triazinyl, benzthiazolyl, furanyl, imidazolyl, indolyl, indolizinyl, isoxazolyl, isoquinolinyl, isothiazolyl, oxadiazolyl, pyrazinyl, pyridazinyl, pyrazolyl, pyridyl, pyrimidinyl, pyrrolyl, quinazolinyl, quinolinyl, 1,3,4-thiadiazolyl, thiazolyl, thienyl, triazolyl, and the like.

“Heteroatom” means an atom other than carbon, for example boron, nitrogen, oxygen, phosphorous, sulfur, silicon, or germanium.

“Heteroaryldiazo” means a heteroaryl-diazo-moiety wherein the heteroaryl and diazo moieties are as defined herein.

“Heteroaryldiyl” means a bivalent radical derived from a heteroaryl, wherein the heteroaryl is as described herein. An exemplary heteroaryldiyl radical is optionally substituted pyridinediyl.

“Heteroaryloxy” means a heteroaryl-O— moiety wherein the heteroaryl moiety is as herein described.

“Heteroaryloxycarbonyl” means a heteroaryl-O—C(═O)— moiety wherein the heteroaryl moiety is as herein defined.

“Heteroarylsulfinyl” means a heteroaryl-S(O)— moiety wherein the heteroaryl moiety is as defined herein.

“Heteroarylsulfonyl” means a heteroaryl-S(O)₂— moiety wherein the aryl moiety is as defined herein.

“Heteroarylsulphonylcarbamoyl” means a heteroaryl-SO₂—NH—C(═O)— moiety wherein the heteroaryl moiety is as herein described.

“Heterocyclenyl” means a non-aromatic monocyclic or multicyclic hydrocarbon ring system of about 3 to about 10 carbon atoms, preferably about 5 to about 10 carbon atoms, in which one or more of the carbon atoms in the ring system is/are heteroatom(s) other than carbon, for example boron, nitrogen, oxygen, phosphorous, sulfur, silicon, or germanium, and which contains at least one carbon-carbon double bond or carbon-nitrogen double bond. Preferably, the ring includes 1 to 3 heteroatoms. Preferred ring sizes of rings of the ring system include about 5 to about 6 ring atoms; and such preferred ring sizes are also referred to as “lower”. The designation of the aza, oxa or thia as a prefix before heterocyclenyl define that at least a nitrogen, oxygen or sulfur atom is present, respectively, as a ring atom. “Substituted heterocyclenyl” means a heterocyclenyl moiety as defined above which is substituted with one or more “ring moiety substituents” (preferably 1 to 3) which may be the same or different and are as defined herein. The nitrogen atom of a heterocyclenyl may be a basic nitrogen atom. The nitrogen or sulfur atom of the heterocyclenyl may also be optionally oxidized to the corresponding N-oxide, S-oxide or S,S-dioxide. Exemplary monocyclic azaheterocyclenyl moieties include 1,2,3,4-tetrahydropyridine, 1,2-dihydropyridyl, 1,4-dihydropyridyl, 1,2,3,6-tetra-hydropyridine, 1,4,5,6-tetrahydropyrimidine, 2-pyrrolinyl, 3-pyrrolinyl, 2-imidazolinyl, 2-pyrazolinyl, and the like. Exemplary oxaheterocyclenyl moieties include 3,4-dihydro-2H-pyran, dihydrofuranyl, and fluorodihydrofuranyl. An exemplary multicyclic oxaheterocyclenyl moiety is 7-oxabicyclo[2.2.1]heptenyl. Exemplary monocyclic thiaheterocyclenyl rings include dihydrothiophenyl and dihydrothiopyranyl.

“Heterocyclyl” means a non-aromatic saturated monocyclic or multicyclic ring system of about 3 to about 10 carbon atoms, preferably about 5 to about 10 carbon atoms, in which one or more of the carbon atoms in the ring system is/are heteroatom(s) other than carbon, for example boron, nitrogen, oxygen, phosphorous, sulfur, silicon, or germanium. Preferably, the ring system contains from 1 to 3 heteroatoms. Preferred ring sizes of rings of the ring system include about 5 to about 6 ring atoms; and such preferred ring sizes are also referred to as “lower”. The designation of the aza, oxa or thia as a prefix before heterocyclyl define that at least a nitrogen, oxygen or sulfur atom is present respectively as a ring atom. “Substituted heterocyclyl” means a heterocyclyl moiety as defined above which is substituted with one or more “ring moiety substituents” (preferably 1 to 3) which may be the same or different and are as defined herein. The nitrogen atom of a heterocyclyl may be a basic nitrogen atom. The nitrogen or sulfur atom of the heterocyclyl may also be optionally oxidized to the corresponding N-oxide, S-oxide or S,S-dioxide. Exemplary monocyclic heterocyclyl rings include piperidyl, pyrrolidinyl, piperazinyl, morpholinyl, thiomorpholinyl, thiazolidinyl, 1,3-dioxolanyl, 1,4-dioxanyl, tetrahydrofuranyl, tetrahydrothiophenyl, tetrahydrothiopyranyl, and the like.

“Ring moiety substituents” mean substituents attached to aromatic or non-aromatic ring systems inclusive of aryl, heteroaryl, hydroxy, alkoxy, cyclyloxy, aryloxy, heteroaryloxy, acyl or its thioxo analogue, cyclylcarbonyl or its thioxo analogue, aroyl or its thioxo analogue, heteroaroyl or its thioxo analogue, acyloxy, cyclylcarbonyloxy, aroyloxy, heteroaroyloxy, halo, nitro, cyano, carboxy (acid), —C(═O)—NHOH, —C(═O)—CH₂OH, —C(═O)—CH₂SH, —C(═O)—NH—CN, sulpho, phosphono, alkylsulphonylcarbamoyl, tetrazolyl, arylsulphonylcarbamoyl, N-methoxycarbamoyl, heteroarylsulphonylcarbamoyl, 3-hydroxy-3-cyclobutene-1,2-dione, 3,5-dioxo-1,2,4-oxadiazolidinyl or hydroxyheteroaryl such as 3-hydroxyisoxazolyl, 3-hydoxy-1-methylpyrazolyl, alkoxycarbonyl, cyclyloxycarbonyl, aryloxycarbonyl, heteroaryloxycarbonyl, alkylsulfonyl, cyclylsulfonyl, arylsulfonyl, heteroarylsulfonyl, alkylsulfinyl, cyclylsulfinyl, arylsulfinyl, heteroarylsulfinyl, alkylthio, cyclylthio, arylthio, heteroarylthio, cyclyl, aryldiazo, heteroaryldiazo, thiol. When a ring system is saturated or partially saturated, the “ring moiety substituents” further include, methylene (H₂C═), oxo (O═) and thioxo (S═). Acidic/amide ring moiety substituents are carboxy (acid), —C(═O)—NHOH, —C(═O)—CH₂OH, —C(═O)—CH₂SH, —C(═O)—NH—CN, sulpho, phosphono, alkylsulphonylcarbamoyl, tetrazolyl, arylsulphonylcarbamoyl, N-methoxycarbamoyl, heteroarylsulphonylcarbamoyl, 3-hydroxy-3-cyclobutene-1,2-dione, 3,5-dioxo-1,2,4-oxadiazolidinyl or hydroxyheteroaryl such as 3-hydroxyisoxazolyl, 3-hydoxy-1-methylpyrazolyl. Non-acidic polar ring moiety substituents are hydroxy, oxo (O═), thioxo (S═), acyl or its thioxo analogue, cyclylcarbonyl or its thioxo analogue, aroyl or its thioxo analogue, heteroaroyl or its thioxo analogue, alkoxycarbonyl, cyclyloxycarbonyl, aryloxycarbonyl, heteroaryloxycarbonyl, acyloxy, cyclylcarbonyloxy, aroyloxy, heteroaroyloxy, alkylsulfonyl, cyclylsulfonyl, arylsulfonyl, heteroarylsulfonyl, alkylsulfinyl, cyclylsulfinyl, arylsulfinyl, heteroarylsulfinyl, thiol.

“Amino acid” means an amino acid selected from the group consisting of natural and unnatural amino acids as defined herein. Amino acid is also meant to include amino acids having L or D stereochemistry at the alpha-carbon. Preferred amino acids are those possessing an alpha-amino group. The amino acids may be neutral, positive or negative depending on the substituents in the side chain. “Neutral amino acid” means an amino acid containing uncharged side chain substituents. Exemplary neutral amino acids include alanine, valine, leucine, isoleucine, proline, phenylalanine, tryptophan, methionine, glycine, serine, threonine and cysteine. “Positive amino acid” means an amino acid in which the side chain substituents are positively charged at physiological pH. Exemplary positive amino acids include lysine, arginine and histidine. “Negative amino acid” means an amino acid in which the side chain substituents bear a net negative charge at physiological pH. Exemplary negative amino acids include aspartic acid and glutamic acid. Preferred amino acids are alpha-amino acids. Exemplary natural amino acids are alanine, isoleucine, proline, phenylalanine, tryptophan, methionine, glycine, serine, threonine, cysteine, tyrosine, asparagine, glutamine, lysine, arginine, histidine, aspartic acid and glutamic acid. “Unnatural amino acid” means an amino acid for which there is no nucleic acid codon. Exemplary unnatural amino acids include, for example, the D-isomers of the natural alpha-amino acids as indicated above; Aib (aminobutyric acid), beta-Aib (3-amino-isobutyric acid), Nva (norvaline), beta-Ala, Aad (2-aminoadipic acid), beta-Aad (3-aminoadipic acid), Abu (2-aminobutyric acid), Gaba (gamma-aminobutyric acid), Acp (6-aminocaproic acid), Dbu (2,4-diaminobutryic acid), alpha-aminopimelic acid, TMSA (trimethylsilyl-Ala), alle (allo-isoleucine), Nle (norleucine), tert-Leu, Cit (citrulline), Om, Dpm (2,2′-diaminopimelic acid), Dpr (2,3-diaminopropionic acid), or beta-Nal, Cha (cyclohexyl-Ala), hydroxyproline, Sar (sarcosine), and the like; cyclic amino acids; Na-alkylated amino acids such as MeGly (Na-methylglycine), EtGly (Na-ethylglycine) and EtAsn (Na-ethylasparagine); and amino acids in which the alpha-carbon bears two side-chain substituents. The names of natural and unnatural amino acids and residues thereof used herein follow the naming conventions suggested by the IUPAC Commission on the Nomenclature of Organic Chemistry and 10 the IUPAC-IUB Commission on Biochemical Nomenclature as set out in “Nomenclature of a-Amino Acids (Recommendations, 1974)” Biochemistry, 14(2), (1975). To the extent that the names and abbreviations of amino acids and residues thereof employed in this specification and appended claims differ from those noted, differing names and abbreviations will be made clear.

“Oligopeptidyl moiety” means a moiety that contains 2 to 8 amino acid moieties connected by amide bonds between the amino acid moieties wherein the amino acids are as defined herein. Amino acid moieties are preferably natural amino acids.

Within the context of this invention, “thiol” and “mercapto” are used interchangeably and mean an —SH moiety.

Within the context of this invention, a “defect site” can be a site for example in a coating layer that is, compared to the same coating layer that is free from defects, empty or differently occupied. For example, a defect site can be a hole in a coating layer. A defect site can also be a different compound that is incorporated into a coating layer.

### DETAILED DESCRIPTION OF THE INVENTION

The monomers of the type R—(N)ₓ-(L)ₘ-(C≡C)ₙ-(L′)ₒ-(N′)_{y}—R′ of the present invention can be prepared by various methods known to the person skilled in the art (see, for example, Schrettl, Chem. Sci. 2015, 6, 564, Szilluweit, Nano Lett. 2012, 12, 2573, Schrettl, Nature. Chem. 2014, 6, 468, Frauenrath, Org. Lett. 2008, 10, 4525). The following procedures serve as examples for the preparation of monomers of the type R—(N)ₓ-(L)ₘ-(C≡C)ₙ-(L′)ₒ-(N′)_{y}—R′ and/or their intermediates, wherein x, m, o, and y are independently 0 or 1 and n is 4 to 12, and wherein R and R′ are either the same or different moieties and L and L′ are either the same or different linker moieties, unless otherwise specified. The monomers and the intermediates can be prepared from commercially available starting materials.

An example of a suitable monomer is hexayne R—(N)ₓ-(L)ₘ-(C≡C)₆-(L′)ₒ-(N′)_{y}—R′. Exemplary starting materials include compounds that comprise a —C≡C—H moiety. For the synthesis of the monomers R—(N)ₓ-(L)ₘ-(C≡C)ₙ-(L′)ₒ-(N′)_{y}—R′, the starting materials can be subjected to a sequence of bromination and palladium-catalyzed cross coupling reactions resulting in an elongation of the oligoyne segment.

In an exemplary procedure for the preparation of monomers of the type R—(N)ₓ-(L)ₘ-(C≡C)ₙ-(L′)ₒ-(N′)_{y}—R′, one can start from a chemically functionalized terminal alkyne R—(N)ₓ-(L)ₘ-C≡C—H and protect the head moiety R with a sterically demanding protecting group R*. This sterically demanding protecting group can serve to avoid premature cross-linking or degradation of the reactive oligoyne moiety in subsequent synthetic steps.

For example, for the synthesis of hexayne monomers and/or intermediates R″OOC—(CH₂)₃—(C≡C)₆—(CH₂)₃—R′, wherein R″ can be R—(N)ₓ—, 5-hexynoic acid can be first converted to the corresponding tritylphenyl ester (Trtph=Ph₃C(C₆H₄)) through an esterification reaction with tritylphenol. This reaction can be followed by a bromination reaction that converts the alkyne into the corresponding bromoalkyne intermediate. The bromoalkyne intermediate can then be subjected to a palladium-catalyzed cross-coupling reaction with the zinc acetylide of another alkyne or oligoyne. For example, the zinc derivative of a diyne can furnish the corresponding triyne intermediate as the reaction product. The copper-catalyzed homocoupling reaction of this triyne intermediate, for example, can give direct access to the symmetric hexayne monomer and/or intermediate TrtphOOC—(CH₂)₃—(C≡C)₆—(CH₂)₃-COOTrtph.

For the preparation of unsymmetric oligoyne monomers and/or intermediates, a different compound with an alkyne or oligoyne moiety can be prepared following substantially the same synthetic procedures. For example, in order to covalently link two different oligoyne intermediates, one of the two can be converted into the oligoyne bromide intermediate while the other can be converted into the corresponding oligoyne zinc acetylide. For example, the trityl phenyl ester with a triyne moiety can be brominated and directly used in the palladium-catalyzed cross-coupling reaction with a triyne zinc acetylide carrying another chemical functional group. This can give access to an unsymmetric hexayne monomer and/or intermediate TrtphOOC—(CH₂)₃—(C≡C)₆-L′-R′ carrying a sterically demanding ester on one side and a different moiety on the other side. For example, to prepare an unsymmetric hexayne monomer and/or intermediate with an alkyl group on the other side, one can employ the zinc acetylide of an alkyltriyne such as pentadeca-1,3,5-triyne. In the same way, an unsymmetric hexayne monomer and/or intermediate with a perfluoroalkyl group on the other side can be obtained from a perfluoro-alkyltriyne such as 9,9,10,10,11,11,12,12,13,13,15,15,15-heptfluoropentadeca-1,3,5-triyne.

An unsymmetric hexayne monomer and/or intermediate with a hydrogen atom on one side can be prepared from zinc acetylides of alkynes, diynes, or triynes with a silyl moiety on one terminus. For example, the coupling of a triyne bromide intermediate equipped with a head moiety as above with a triisopropylsilyl-protected triyne zinc acetylide can furnish the triisopropylsilyl-substituted hexayne monomer and/or intermediate. Other silyl moieties can be used on the terminal acetylene carbon, as well, such as trimethylsilyl or triethylsilyl moieties. The removal of the silyl group can be readily achieved by employing a fluorine source, so that a hexayne monomer and/or intermediate with a terminal hydrogen atom is obtained.

In the same way, symmetric and unsymmetric oligoyne monomers of the type R—(N)ₓ-(L)ₘ-(C≡C)ₙ-(L′)ₒ-(N′)_{y}—R′ with other types of terminal moieties can be obtained from different alkynes R—(N)ₓ-(L)ₘ-C≡C—H. For example, the hydroxyl-functionalized hexayne monomers and/or intermediates R*O—(CH₂)₃—(C≡C)₆—(CH₂)₃—OR* and R*O—(CH₂)₃—(C≡C)₆-(L′)ₒ-(N′)_{y}—R′ equipped with a sterically demanding protecting moiety R* for the hydroxyl function, including but not limited to a trityl moiety, an acyl moiety such as a pivaloyl moiety, or a silyl moiety such as triisopropylsilyl, tert-butyldimethylsilyl, or tert-hexyldimethylsilyl, can be obtained by converting 4-pentynol with the corresponding trityl, acyl, or silyl chloride, and otherwise following the procedures described above. Likewise, symmetric and unsymmetric hexaynes monomers and/or intermediates R*S—(CH₂)₃—(C≡C)₆—(CH₂)₃—SR* and R*S—(CH₂)₃—(C≡C)₆-(L′)ₒ-(N′)_{y}—R′ with thiol functions protected with a sterically demanding protecting moiety, R* including but not limited to a trityl moiety or a fluorenylmethyl moiety, can be obtained by reacting 4-pentynthiol with the corresponding trityl chloride or the fluorenylmethyl tosylate. Symmetric and unsymmetric hexayne monomers and/or intermediates R*NH—(CH₂)₃—(C≡C)₆—(CH₂)₃—NHR* and R*NH—(CH₂)₃—(C≡C)₆-(L′)ₒ-(N′)_{y}—R′ with amine functions protected with sterically demanding protecting moieties R* including but not limited to fluorenylmethoxycarbonyl (Fmoc) can be obtained by reacting 4-pentynamine with fluorenylmethoxycarbonyl chloride. In all exemplary cases, the following reaction steps towards the final symmetric and unsymmetric hexayne monomers are preferably the same as those described in the previous paragraphs.

Preferred monomers are monomers of the type R—(N)ₓ-(L)ₘ-(C≡C)₆-(L′)ₒ-(N′)_{y}—R′. These preferred monomers can be symmetric or unsymmetric. It has been found that the carbon content of a corresponding film of the preferred monomers on a surface most closely matches the amount of carbon needed for an atomically dense carbon monolayer.

Nevertheless, the described exemplary schemes of synthetic procedures can also provide access to monomers and/or intermediates with shorter or longer oligoyne moieties, such as the corresponding monomers and/or intermediates, wherein the oligoyne moiety is a tetrayne, pentayne, heptayne, or octayne. Advantageously, monomers and/or intermediates that feature an odd number of acetylene units (that is, n is odd) are prepared by the cross-coupling methodology described herein. For example, the cross-coupling of a triyne bromide with a diyne zinc acetylide gives a pentayne monomer and/or intermediate. Depending on the moieties of the triyne bromide and the diyne zinc acetylide, both symmetric and unsymmetric pentayne monomers and/or intermediates can be prepared in this way.

Preferably, unsymmetric monomers and/or intermediates with an even number of acetylene units in the oligoyne moiety (that is, n is even) are prepared by the cross-coupling methodology described herein. For example, an unsymmetric monomer and/or intermediate with an oligoyne moiety, wherein n is 4, can be prepared by the cross-coupling reaction of a triyne bromide with an alkyne.

A symmetric tetrayne monomer and/or intermediate can be directly accessed through a homocoupling reaction of a diyne intermediate. Accordingly, symmetric octayne monomers and/or intermediates can be prepared by the homocoupling of the respective tetrayne intermediates. Unsymmetric octayne monomers and/or intermediates can be prepared by the cross-coupling of a tetrayne bromide monomer and/or intermediate with a tetrayne zinc acetylide.

Moreover, based on the described exemplary procedures, monomers and/or intermediates with various spacers L and L′ can be prepared. For example, following the exemplary procedures described herein and starting from omega-octynoic, omega-heptynoic, or omega-pentynoic, or omega-butynoic acid the corresponding symmetric or unsymmetric oligoyne monomers and/or intermediates such as the symmetric or unsymmetric hexayne intermediates with protected acid moieties and pentylene, butylene, ethylene, or methylene spacers can be prepared. This can be used analogously for intermediates with other moieties R#, wherein R# can be an appropriate moiety as described herein with the exception of —COOH, starting from appropriately functionalized terminal alkynes R^{#}—(N)ₓ-(L)ₘ-C≡C—H, respectively. Using the resulting intermediates, the corresponding monomers can be prepared using the procedures described herein.

An alternative exemplary pathway towards further symmetric and unsymmetric oligoyne monomers of the type R—(N)ₓ-(L)ₘ-(C≡C)ₙ-(L′)ₒ-(N′)_{y}—R′ is by way of functional group interconversion of intermediates and/or monomers F—(N)ₓ-(L)ₘ-(C≡C)ₙ-(L′)ₒ-(N′)_{y}—F′, wherein F and F′ independently may be appropriate moieties as described herein. This exemplary divergent synthetic pathway is a versatile alternative because it gives straightforward access to a large variety of differently functionalized compounds starting from the same oligoyne intermediate and/or monomer that is then produced on a larger scale and in an optimized reaction sequence. For example, the symmetric or unsymmetric hexayne esters R*OOC—(CH₂)₃—(C≡C)₆—(CH₂)₃—COOR* or R*OOC—(CH₂)₃—(C≡C)₆-(L′)ₒ-(N′)_{y}—R′ can be subjected to a saponification under alkaline conditions to yield the corresponding hexayne monomer with one or two carboxylic acid functions. Alternatively, the symmetric or unsymmetric hexayne esters R*OOC—(CH₂)₃—(C≡C)₆—(CH₂)₃—COOR* or R*OOC—(CH₂)₃—(C≡C)₆-(L′)ₒ-(N′)_{y}—R′ can be reduced with suitable reducing agents such as lithium aluminum hydride to directly yield the corresponding hexayne monomers with one or two hydroxyl functions.

Moreover, various other chemical functional groups can be introduced by carrying out transesterification reactions with appropriate alcohol derivatives. In the following, exemplary procedures are described. For example, a transesterification of either the unsymmetric hexayne intermediate and/or monomer R*OOC—(CH₂)₃—(C≡C)₆-(L′)ₒ-(N′)_{y}—R′ or the symmetric hexayne intermediate and/or monomer *ROOC—(CH₂)₃—(C≡C)₆—(CH₂)₃—COOR* with tri(ethylene glycol) monomethyl ether under alkaline conditions can furnish the corresponding hexayne monomers and/or intermediates with one or two tri(ethylene glycol) segments, respectively. The transesterification of the aforementioned monomers and/or intermediates with a perfluoroalkyl alcohol under alkaline conditions can provide the unsymmetric or symmetric perfluoroalkyl-substituted hexaynes monomers and/or intermediates. The transesterification of the aforementioned monomers and/or intermediates with glycidol can provide the unsymmetric or symmetric glycidol-substituted hexayne monomer and/or intermediate.

In further exemplary procedures, the deprotection of the unsymmetric or symmetric hexayne monomers and/or intermediates R*O—(CH₂)₃—(C≡C)₆—(CH₂)₃—OR* or R*O—(CH₂)₃—(C≡C)₆-(L′)ₒ-(N′)_{y}—R′ followed by esterification with acid chlorides or acid anhydrides, or the addition to isocyanates can provide other monomers and/or intermediates. For example, the reaction of HO—(CH₂)₃—(C≡C)₆—(CH₂)₃—OH or HO—(CH₂)₃—(C≡C)₆-(L′)ₒ-(N′)_{y}—R′ with methacryloyl chloride can be used to prepare hexayne monomers and/or intermediates with one or two polymerizable methacrylate moieties. In another example, the addition of HO—(CH₂)₃—(C≡C)₆—(CH₂)₃—OH or HO—(CH₂)₃—(C≡C)₆-(L′)ₒ-(N′)_{y}—R′ to triethoxysilylpropylisocyanate can be used to prepare unsymmetric or symmetric hexayne monomers and/or intermediates with one or two triethoxysilyl moieties.

In further exemplary procedures, the deprotection of the symmetric or unsymmetric hexayne intermediates R*S—(CH₂)₃—(C≡C)₆—(CH₂)₃—SR* or R*S—(CH₂)₃—(C≡C)₆-(L′)ₒ-(N′)_{y}—R′ followed by thiol-ene reactions to Michael systems can be used to introduce further moieties. For example, the thiol-ene reaction with vinylphosphonates such as diethoxyvinylphosphonate yields unsymmetric or symmetric hexayne monomers and/or intermediates with one or two phosphonate moieties, respectively. These phosphonate moieties can be the head and tail moieties of the monomers, respectively.

It will be understood that the exemplary procedures described above can also be employed for monomers and/or intermediates with longer or shorter oligoyne moieties. The exemplary procedures described above can also be employed for monomers and/or intermediates with longer or shorter linker moieties.

With the exemplary procedures for the preparation of monomers and/or intermediates described herein, symmetric and/or unsymmetric oligoyne monomers of the type R—(N)ₓ-(L)ₘ-(C≡C)ₙ-(L′)ₒ-(N′)_{y}—R′, with differently long oligoyne moieties and different linkers can be prepared. The monomers of the type R—(N)ₓ-(L)ₘ-(C≡C)ₙ-(L′)ₒ-(N′)_{y}—R′ can have as head moiety and/or tail moiety one or two terminal (protected) carboxylic acids (and their derivatives such as esters, amides, peptides, and oligopeptides), trihalosilanes, trialkoxysilanes, amines (and their derivatives such as urethanes, peptides and oligopeptides), phosphines, phosphonic acids (and their derivatives such as alkyl or aryl phosphonates and phosphonamides), alcohols (including diols and polyols, ethers, urethanes, oligo(ethylene oxide)s of different lengths, thiols, sulfonic acids (and their derivatives such as alkyl or aryl sulfonates and sulfonamides), halogens, isocyanates, oligo(ethylene oxide)s, linear or branched alkyl groups, linear perfluoroalkyl groups, as well as polymerizable groups such as acrylates, methacrylates, styrenes, and epoxides.

According to an embodiment of the invention, the head moiety R of the monomers is selected from the group consisting of branched or unbranched alkyl, branched or unbranched haloalkyl, branched or unbranched alkenyl, branched or unbranched perfluoroalkyl, C₆F₁₃C₆H₁₂—, oligoethylenoxy such as triethylene glycol monomethyl ether or tetraethylene glycol monomethyl ether or pentaethylene glycol monomethyl ether or hexaethylene glycol monomethyl ether, phenyl, tetrafluorophenyl, benzyl, aryl, C₁-C₄-alkyl-substituted aryl, in particular tolyl, heteroaryl, carboxy, ester, carboxamide, carbamoyl, oligopeptidyl, amine, halo, hydroxyl, mercapto, acryloyl, methacryloyl, styryl, isocyanate, sulfonyl hydroxide, C₁-C₄-alkyl-substituted arylsulfonyloxy, in particular toluene sulfonyloxy, phosphono or its derivatives, in particular diethylphosphono ((EtO)₂P(═O)—), phosphate or its derivatives, oxiranyl, trihalosilyl, and trialkoxysilyl. Particularly preferred head moieties R are selected from the group consisting of phosphonic acid and its derivatives, in particular diethylphosphono ((EtO)₂P(═O)—), phosphate and its derivatives, carboxy, hydroxyl, mercapto, oligoethylenoxy such as triethylene glycol monomethyl ether, oxiranyl, C₁-C₄-alkyl-substituted arylsulfonyloxy, in particular toluene sulfonyloxy, tolyl, tetrafluorophenyl, trihalosilyl, and trialkoxysilyl. The use of these head moieties allows for an effective binding to the surface of the solid substrate. This effective binding to the surface improves the adhesion of the coating to the surface.

According to a further embodiment of the invention, the tail moiety R′ of the monomers is selected from the group consisting of —H, branched or unbranched alkyl, branched or unbranched haloalkyl, branched or unbranched alkenyl, branched or unbranched perfluoroalkyl, C₆F₁₃C₆H₁₂—, oligoethylenoxy such as triethylene glycol monomethyl ether or tetraethylene glycol monomethyl ether or pentaethylene glycol monomethyl ether or hexaethylene glycol monomethyl ether, phenyl, tetrafluorophenyl, benzyl, aryl, C₁-C₄-alkyl-substituted aryl, in particular tolyl, heteroaryl, carboxy, ester, carboxamide, carbamoyl, oligopeptidyl, amine, halo, hydroxyl, mercapto, acryloyl, methacryloyl, styryl, isocyanate, sulfonyl hydroxide, C₁-C₄-alkyl-substituted arylsulfonyloxy, in particular toluene sulfonyloxy, phosphono or its derivatives, in particular diethylphosphono ((EtO)₂P(═O)—), phosphate or its derivatives, oxiranyl, trialkylsilyl, trimethylsilyl, triethylsilyl, tri isopropylsilyl, trihalosilyl, and trialkoxysilyl. Particularly preferred tail moieties R′ are selected from the group consisting of unbranched alkyl, unbranched perfluoroalkyl, phosphonic acid and its derivatives, in particular diethylphosphono ((EtO)₂P(═O)—), phosphate and its derivatives, mercapto, oligoethylenoxy such as triethylene glycol monomethyl ether, oxiranyl, C₁-C₄-alkyl-substituted arylsulfonyloxy, in particular toluene sulfonyloxy, tolyl, tetrafluorophenyl, trialkylsilyl, trimethylsilyl, triethylsilyl, tri isopropylsilyl, trihalosilyl, and trialkoxysilyl.

According to another embodiment of the invention, the linker components L and/or L′ of the monomers are independently selected from the group consisting of methylene, ethylene, propylene, butylene, pentylene. These linker moieties allow for a particularly effective packing of the oligoyne moieties of the monomers. This aids in obtaining a coating that is substantially free from defect sites.

According to another embodiment of the invention, the tail moiety R′ allows for an interaction with the surface of a solid substrate of the same or a different material.

According to yet another embodiment of the invention, the head moiety R and the tail moiety R′ are identical.

According to another embodiment of the invention, the head moiety R and the tail moiety R′ are different. For this embodiment, the head moiety R and the tail moiety R′ of the monomer can also have different polarities, for example the head moiety R can be more hydrophilic and the tail moiety R′ can be less hydrophilic or the other way around. Alternatively, the head moiety R can be more hydrophobic and the tail moiety R′ can be less hydrophobic or the other way around.

According to another embodiment of the invention, the polarities of the head moiety R and/or the tail moiety R′ can be different from the polarities of the linker moieties L and/or L′ and/or the oligoyne moiety (C≡C)ₙ. For example, the head moiety R and/or the tail moiety R′ can be more hydrophilic than the linker moieties L and/or L′ and/or the oligoyne moiety (C≡C)ₙ.

If the polarities of the head moiety R and the tail moiety R′ of a monomer are different from each other or if the polarities of the head moiety R and the tail moiety R′ of a monomer are different from the polarities of the linker moieties L and/or L′ and/or the oligoyne moiety (C≡C)ₙ, these monomers can represent a new type of surfactant. In this new type of surfactant, the reactive oligoyne moiety can serve as a molecular carbon precursor. Further, the head moiety R and/or the tail moiety R′ of this new type of surfactant can be chosen such that they can allow for an interaction with the surface of a solid substrate. The type of interaction between the head moiety and/or the tail moiety can be as described further below.

Preferred monomers are unsymmetric hexayne monomers with a head moiety R selected from the group consisting of —COOH, —COOMe, phosphonic acid and its diethyl ester, sulfonic acid, thiol, epoxide, triethoxysilane, and a tail moiety R′ selected from the group consisting of dodecyl or F₁₃C₆C₆H₁₂—, and heptafluorododecyl. Other preferred monomers are symmetric hexayne monomers wherein the head moiety R and the tail moiety R′ are identical and are selected from the group consisting of —COOH, —COOMe, phosphonic acid and its diethyl ester, sulfonic acid, thiol, epoxide, triethoxysilane. Hexayne monomers with these head moieties R and tail moieties R′ can provide particularly strong binding to solid substrates such as for example noble metals, non-noble metals, and their metal oxides, including but not limited to aluminum, aluminum oxide, iron, steel, iron oxide, titanium, titanium oxide, magnesium, magnesium oxide, zinc, zinc oxide, chrome, chrome oxide, copper, copper oxide, indium tin oxide, silver, silver oxide, nickel, gold, palladium, or their alloys, as well as polymer surfaces such as polyamides such as Nylon-6 or Kevlar, semiaromatic polyamides, polyesters such as poly(lactic acid) (PLA), PET, PEN, vinyl and acrylic polymers such as poly(vinyl alcohol), poly(vinyl acetate), poly(vinylidene chloride), poly(ethylene), poly(propylene), poly(methyl methacrylate), poly(acrylic acid) or their copolymers. By careful choice of the tail moiety R′ of an unsymmetric hexayne monomer, the specific adhesion to another layer can be achieved, or the surface properties can be controlled.

According to another embodiment of the invention, the monomers of the type R—(N)ₓ-(L)ₘ-(C≡C)ₙ-(L′)ₒ-(N′)_{y}—R′ can self-assemble into monolayers at interfaces, for example at the air-water interface, the oil-water interface, or a solid surface in contact with water or an organic solvent.

According to the invention, the monomers are brought into contact with the solid substrate wherein the interaction of the head moieties of the monomers with the surface of the solid substrate induces at least a part of the monomers to align in a defined manner thereby forming a film on the surface. Depending on the amount of monomers per surface area, the film formed by the monomers on the surface of the substrate can be a monolayer or a multilayer, for example a double layer or a triple layer. In case of a monolayer, the majority, preferably all, of the head moieties of the monomers are in contact with the surface of the substrate. In case of a multilayer, only a part of the head moieties of the monomers is in contact with the surface of the substrate. “Bringing the monomers into contact” can therefore mean that at least a substantial part of the monomers is brought into direct contact. For example, in the case of a multilayer, the majority of the monomers in the layer that is closest to the surface of the substrate is in contact with the surface of the substrate.

The monomers can be brought into contact with the solid substrate by various means. The following procedures serve as examples for pathways to bring the monomers into contact with the solid substrate.

For example, the monomers of the type R—(N)ₓ-(L)ₘ-(C≡C)ₙ-(L′)ₒ-(N′)_{y}—R′ can form a self-assembled monolayer by spreading them on the water surface from a dilute solution in an organic solvent such as chloroform that is immiscible with the aqueous subphase. After evaporation of the solvent, the surface area of the air-water interface can be reduced by compression, for example with the moveable barriers of a Langmuir trough. The compression can be monitored by means of the surface pressure through the surface pressure microbalance, and the compression can be continued until the change in surface pressure indicates that the monomers are in close contact, for example in a condensed state. Alternatively, such monolayers as well as multilayers of such monolayers can be achieved by simply spreading the monomers on the water surface from a dilute solution in a water-immiscible organic solvent (applied to the water surface by simple casting or spraying techniques) such as chloroform at a monomer concentration that ensures a dense coverage of the whole water surface with a monomer monolayer or a multilayer.

The monomer monolayers or multilayers obtained at the air-water interface can then be transferred to an appropriately chosen solid substrate by different techniques. For example, a suitable hydrophilic solid substrate such as a silicon oxide wafer can be immersed in the subphase (for example in the aqueous phase) and vertically aligned to the air-water interface before spreading the monomers on the water surface. After spreading of the monomer, the solid substrate can be carefully removed, by pulling it slowly out of the water. This procedure can be employed for the transfer of monomers in the form of a monolayer or a multilayer to any solid substrate with a sufficiently hydrophilic surface such as metals, metal oxides, or glass, in particular silicon, steel, iron, tin, aluminum, aluminum oxide, in particular sapphire, or silicon dioxide. Moreover, this procedure can allow for the transfer of monomers in the form of a monolayer or a multilayer to different classes of polymeric substrates, in particular polyamides such as Nylon-6 or Kevlar, semiaromatic polyamides, polyesters such as poly(lactic acid), PET, PEN, vinyl and acrylic polymers such as poly(vinyl alcohol), poly(vinyl acetate), poly(vinylidene chloride), poly(ethylene), poly(propylene) or their copolymers. Monomer multilayers can also be prepared on the solid substrate by repeating this procedure.

In another exemplary procedure, after spreading of the monomer on the water surface and formation of a monomer monolayer or multilayer at the air-water interface, this monomer monolayer or multilayer can also be transferred to a solid substrate by the slow removal of the water subphase, in a way so that the monomer monolayer or multilayer slowly sinks onto the surface of a solid substrate that has been immersed in the trough prior to the spreading of the monomers. This transfer technique can be universally employed for any type of substrate including but not limited to noble metals, non-noble metals, metal oxides, glasses, ceramics, or polymers. For example, a monomer monolayer or multilayer with its hydrophilic groups (such as carboxylic acids, esters, phosphonic esters, or phosphonates) oriented towards the aqueous subphase and its hydrophobic dodecyl or heptafluorododecyl chains oriented towards the air can be transferred to hydrophilic substrates, such as a silicon wafer (with a thermal SiO₂ surface layer), a steel slide, a metal electrode, as well as an aluminum oxide and a titanium oxide substrate in this manner.

In a further exemplary procedure, a monomer monolayer or multilayer can be transferred from the air-water interface onto a solid substrate by moving a solid substrate to the interface from above until the subphase wets the solid substrate. Thereafter, the solid substrate can be slowly removed from the interface while ensuring that the monomer monolayer or multilayer covers the substrate. This transfer technique can be employed with any type of substrate to which the respective monomers of the monomer monolayer or multilayer adhere, preferably adhere specifically. For example, a monomer monolayer or multilayer with the hydrophilic moieties (such as carboxylic acids, esters, phosphonic esters, or phosphonates) oriented towards the aqueous subphase and hydrophobic dodecyl or heptafluorododecyl moieties oriented towards the air can be transferred to hydrophobic substrates such as octadecyl-trichlorosilane-covered silicon, gold substrates, or copper substrates or hydrophobic polymers such as poly(ethylene), PET, PEN, PTFE.

Using the procedures described above, monomer monolayers and multilayers can for example be obtained from unsymmetric and/or symmetric hexayne monomers, for example with either a carboxylic acid, carboxylic acid ester, phosphonic acid, or phosphonic acid ester head moiety and a dodecyl, carboxylic acid, carboxylic acid ester, phosphonic acid, or phosphonic acid ester tail moiety on silicon wafers, aluminum oxide, sapphire, or mica substrates, glass substrates, gold-covered glass slides, as well as tin, steel and iron substrates. For example, this method can also be used to produce monolayers from the unsymmetric hexayne derivatives with either a carboxylic acid, carboxylic acid ester, phosphonic acid, or phosphonic acid ester head moiety and a dodecyl tail moiety on silicon wafers, titanium oxide, aluminum oxide, sapphire or mica substrates, glass slides, gold-covered glass slides, aluminum substrates, or steel slides. In addition, this procedure can for example be used to produce monomer monolayers from the hexayne monomers with either an epoxide, hydroxyl, alkyl, or amide head moiety and a dodecyl tail moiety on Nylon-6, PET, PEN, poly(lactic acid), polyvinyl alcohol), poly(ethylene), and poly(propylene) substrates.

According to a further embodiment of the invention, the monomers are brought into contact with the solid substrate in solution in a solvent that wets the surface of the solid substrate. This facilitates a substantially homogeneous distribution of the monomers on the substrate. Preferably, said solution is brought into contact with said surface by painting, spraying, coating, dipping, immersion and/or casting.

For example, monomer films, in particular in the form of self-assembled monolayers, can be obtained on surfaces of suitable solid substrates if (one of) the head moiety R is chosen such that it provides a specific binding to the surface of the substrate. For this purpose, for example, a solution of the monomers in a suitable organic solvent that wets the surface of the substrate can be applied to the surface by different techniques, including painting, spraying, coating, dipping, immersion, or casting techniques. For example, aluminum oxide and other metal or metal oxide substrates can be immersed in a solution of monomer with a head moiety selected from the group consisting of a carboxylic acid, phosphonic acid, or phosphonate for a few minutes. The substrate can thereafter slowly be removed from the solution, and the residual solvent is preferably allowed to evaporate. The coated aluminum oxide surface can be directly used in further steps of the method or first washed with the pure solvent to remove any excess monomer.

In the same way, for example, monomers with a thiol head moiety can be applied to gold or other noble metal surfaces. Using this procedure, monomers with a triethoxysilane head moiety can, for example, also be applied to glass or quartz surfaces. With this procedure, for example, monomers with an alcohol- or epoxide head moiety can also be applied to polymer substrates such as PET, PEN, poly(lactic acid), poly(amide), or poly(vinyl alcohol).

Besides the above described exemplary dipping of the solid substrate into a solution of the monomers, spraying, painting, coating, or casting techniques can for example be employed to bring the monomers into contact with the solid substrate. In another exemplary procedure, a monolayer of an unsymmetric hexayne monomer with a phosphonate head moiety and a dodecyl tail moiety on an aluminum oxide substrate can be obtained by immersion of the solid substrate in a monomer solution. This procedure can be advantageous since with the substrate prepared in this manner, films in which the oligoyne moieties can be easily cross-linked can be obtained. In both cases, the resulting coating can be strongly bound to the aluminum oxide substrate. For example, a multilayer film of a symmetric hexayne monomer with an epoxide as a head moiety and an epoxide as a tail moiety can be formed on a PET substrate by drop-casting a solution of the monomer onto the substrate.

According to another embodiment of the invention, the interaction of the head moiety R of the monomers with the surface of the solid substrate is specific binding. Advantageously, this specific binding allows for reversible and/or dynamic bond formation between the head moiety R and the surface of the substrate at room temperature.

According to yet another embodiment of the invention, the specific binding allows for the formation of covalent or non-covalent bonds between the head groups R and the surface of the solid substrate using the head moieties R of the monomers as ligands that have an affinity to a matching receptor site on the surface of the solid substrate. The formation of the bonds may involve a chemical reaction. Advantageously, the strength of the bonds of the specific binding is from 5 kJ/mol to 460 kJ/mol, particularly from 10 kJ/mol to 200 kJ/mol, more particularly from 10 kJ/mol to 100 kJ/mol. Such bonds allow the monomers to align in such a way that the oligoyne moieties of the monomers are in close contact. For example, the head moieties may bind to specific materials surfaces through covalent bonds, coordinative bonds, ionic interactions, dipolar interactions, hydrogen bonds, van der Waals interactions, or a combination thereof. This can allow for the preparation of a cross-linked coating that is substantially free from defect sites.

The interaction of the head moiety R with the surface of the solid substrate can be important both for the adhesion of the monomers and/or for the adhesion of the coatings. For example, monomers and/or coatings with carboxylic acid, carboxylic acid ester, phosphonic acid, phosphonic acid ester, sulfonic acid, thiol, or triethoxysilane functions can provide binding to noble metals, non-noble metals, and their metal oxides, including but not limited to aluminum, aluminum oxide, rubis, steel, iron, iron oxide, tin, tin oxide, solder, titanium, titanium oxide, magnesium, magnesium oxide, zinc, zinc oxide, chrome, chrome oxide, copper, copper oxide, brass, indium tin oxide, silver, silver oxide, nickel, gold, palladium, platinum, osmium, silicon, silicon oxide, cobalt, tantalum, zirconium, zirconium oxide, as well as their alloys and composites. Moreover, ceramics, glasses, thermoplastic polymers, elastomers, cross-linked polymers, resins, and nanocomposites, for instance epoxies used in microelectronics, can be also used as substrates for the current invention.

Examples for this specific binding may include:
hydroxyl moieties for a silicon surface; this specific binding may include the formation of covalent bonds;
hydroxyl moieties for polymers and polymeric resins such as epoxy resins and polyesters such as PET, PEN, or PLA; this specific binding may include the formation of covalent bonds for example via ring opening and/or transesterification;
hydroxyl moieties for polymers such as polyamide, polyurethanes, poly(vinyl alcohol); this specific binding may include the formation of hydrogen bonds;
carboxyl moieties for aluminum, iron, titanium, silver, and their oxides; this specific binding may include the formation of monodentate ionic and/or dipolar bonds;
amine moieties for mica and stainless steel; this specific binding may include the formation of ionic and/or dipolar bonds;
mercapto (or thiol) moieties for late transition metals such as gold, silver, copper, nickel, palladium, platinum, steel, and zinc; this specific binding may include the formation of thiol-metal bonds;
phosphonic acid or phosphonic acid derivative moieties for aluminum, aluminum oxide, magnesium, magnesium oxide, steel, indium tin oxide, mica, titanium, titanium dioxide, zirconium, zirconium oxide; this specific binding may include the formation of bidentate ionic and/or dipolar bonds;
phosphate or phosphate derivative moieties for aluminum oxide, tantalum oxide, and titanium oxide; this specific binding may include the formation of tridentate ionic and/or dipolar bonds;
trialkoxysilane or trihalosilane moieties for glass, indium tin oxide, titanium dioxide, zirconium oxide, and polyamines such as poly(ethylene imine); this specific binding may include the formation of covalent bonds;
oxiranyl (or epoxide) moieties for polyesters such as PET, PEN, and PLA; this specific binding may include the formation of covalent bonds by ring-opening of the epoxide and/or transesterification;
isocyanate moieties for polymers such as polyamides and polyurethanes including Nylons such as Nylon-6, Nylon-6,6, Nylon-6,10, and semiaromatic polyamides, and polyaramides such as Kevlar®; this specific binding may include the formation of covalent bonds;
acryloyl, methacryloyl, styryl, or vinyl-substituted phenyl moieties with polymers such as olefinic, dienic, methacrylic, acrylic, and vinylic polymers such as poly(vinyl acetate), poly(vinyl alcohol), poly(vinylidene chloride), poly(isoprene), poly(methyl methycrylate); this specific binding may include the formation of covalent bonds, for example by polymerization of the moieties.

According to the invention, at least part of the monomers align in a defined manner. Preferably, most of the monomers align in a defined manner.

According to an embodiment of the invention, at least part of the monomers align such on the surface that a diffractogram measured in the plane of the film displays at least a first-order reflection. This applies in particular to flat substrate surfaces. Examples for such diffractograms can be X-ray diffractograms, in particular obtained by grazing incidence X-ray diffraction. Methods to obtain such diffractograms are known to the skilled person.

According to another embodiment of the invention, at least part of the monomers align such on the surface that the centers of gravity of the oligoyne moieties of the monomers are on a regular lattice within the immediate surroundings of a monomer. Preferably, the immediate surroundings of a monomer are within a radius of at least 0.5 nm, in particular at least 1 nm, more particularly at least 2 nm or at least 3 nm, from the center of gravity of the oligoyne moiety of that monomer. Such an arrangement can help in the preparation of a coating that is substantially free from defects and/or has a defined density and/or nature of functional moieties on at least one of the sides of the coating. Methods to determine the center of gravity of the oligoyne moieties are known to the skilled person. For example, the center of gravity of the oligoyne moiety can be obtained by calculation assuming the mass of the carbon atoms to be point shaped using the formula rₛ=1/M Σⁿᵢ₌₁ mᵢrᵢ, wherein rₛ is the coordinate vector of the center of gravity of the oligoyne moiety, M is the total mass of the oligoyne moiety, and mᵢ and rᵢ are the mass and the coordinate vectors of the individual atoms in the oligoyne moiety, respectively. For the bond lengths and the atomic weights, standard tabulated values can be used for the calculation. Standard tabulated values can for example be found in CRC Handbook of Chemistry and Physics, David R. Lide (editor-in-chief), 84^{th} edition, 2003-2004, CRC Press, pages 1-12 and 9-27 (the bond lengths in 1,3-butadiyne can be used for example for the bond lengths of the carbon-carbon single and carbon-carbon triple bonds in the oligoyne moiety). For this calculation, the origin of the coordinate system can be defined as one of the carbon atoms, in particular one of the terminal carbon atoms, which may simplify the calculation.

According to the invention, at least part of the monomers align in a defined manner on the surface of the solid substrate thereby forming a film on the surface and bringing the oligoyne moieties of the monomers into close contact with each other. According to an embodiment of the invention, the close contact of the oligoyne moieties of the monomers is van-der-Waals contact. This allows for the preparation of an at least partially cross-linked coating under mild conditions. This can also allow for the preparation of a coating that is substantially free from defects.

According to the invention, the head moiety allows for an interaction with the surface of the solid substrate. According to an embodiment of the invention, the head moieties R of the monomers are in contact with the surface of the solid substrate. The contact of the monomers with the surface of the solid substrate may be via specific binding as specified herein.

According to another embodiment of the invention, the oligoyne moieties of the monomers are substantially devoid of contact with the surface of the solid substrate. Advantageously, each monomer has a long axis defined as the axis through the two carbon atoms of the oligoyne moiety that are farthest apart from each other and that the monomers are oriented with their respective long axes standing up from the surface of the solid substrate. Practical experiments have shown that an orientation of the monomers in which the oligoyne moieties of the monomers are substantially in contact with the surface of the solid substrate, cross-linking of the resulting film may be difficult. If the oligoyne moieties are substantially devoid of contact with the surface of the solid substrate, and, particularly, if their respective long axes as defined herein are oriented away from the surface, in particular, if their respective long axes are standing up from the surface, it has been found that it may be easier to induce at least partial cross-linking of the resulting film.

According to a further embodiment of the invention, the film on the surface has a thickness of from 0.1 to 500 nm, particularly from 0.1 to 250 nm, more particularly from 0.1 to 100 nm or from 0.2 to 50 nm or from 0.3 to 30 nm or from 0.5 to 10 nm.

According to the invention, a reaction between oligoyne moieties is induced by providing an external stimulus. According to an embodiment of the invention, the external stimulus is heat, electromagnetic irradiation, and/or a chemical radical initiator. Examples for electromagnetic irradiation are irradiation with UV light (UV irradiation), irradiation with visible light, and irradiation with X-rays. Examples for chemical radical initiators are azoisobutyronitril, dibenzoylperoxide, dilauroylperoxide, di-tert-butyl-peroxide, diisopropylperoxidicarbonate, and potassium persulfate. Preferably, the external stimulus is UV irradiation. Examples for suitable sources for UV irradiation are a 250 W gallium-doped iron halide lamp, a Hg lamp, a laser, or an LED lighting source. This allows for a mild at least partial cross-linking of the film. Mild conditions may aid in obtaining a coating that is substantially free from defects. In addition, mild conditions may allow to maintain the head and/or tail moieties unchanged at the coating layer which may allow for specific binding and hence good adhesion of the coating layer to the substrate and/or to layers above.

According to another embodiment of the invention, the reaction between oligoyne moieties is a carbonization reaction. A carbonization reaction allows for a good at least partial cross-linking of the film.

According to a further embodiment of the invention, the reaction between oligoyne moieties is induced and/or conducted at a temperature from 25 to 200° C., preferably from 25 to 100° C., more preferably from 25 to 50° C. This allows for a mild at least partial cross-linking of the film. Mild conditions may aid in obtaining a coating that is substantially free from defects. In addition, mild conditions may allow to maintain the head and/or tail moieties unchanged at the coating layer which may allow for specific binding and hence good adhesion of the coating layer to the substrate and/or to layers above.

For example, a monolayer of an unsymmetric and/or a symmetric hexayne monomer with a carboxylic acid or ester head moiety and a carboxylic acid, carboxylic acid ester, or dodecyl tail moiety can be spread at the air-water interface and subsequently transferred to a silicon substrate thereby forming a film on the silicon substrate using the procedures described herein. Subsequently, the film on the silicon substrate can be exposed to irradiation with a UV lamp (such as a 250 W gallium-doped iron halide lamp, a Hg lamp, or an LED lighting source), inducing a reaction between oligoyne moieties. This can, for example, lead to the formation of a coating strongly bound to the silicon substrate. In another exemplary procedure, a monolayer of an unsymmetric hexayne monomer with a phosphonate head moiety and a dodecyl tail moiety on an aluminum oxide substrate can be obtained by immersion of the solid substrate in a monomer solution as described above. For this film, a reaction between oligoyne moieties can be induced using for example irradiation, such as with a UV lamp (such as a 250 W gallium-doped iron halide lamp, a Hg lamp, or an LED lighting source), and/or by thermal annealing at temperatures above 25° C., in particular above 100° C. In another exemplary procedure, a multilayer film of a symmetric hexayne monomer with an epoxide as a head moiety and an epoxide as a tail moiety can be formed on a PET substrate by drop-casting a solution of the monomer onto the substrate as described above. Subsequently, a reaction between oligoyne moieties can be induced for example by irradiating the substrate, for example with a UV lamp such as a 250 W gallium-doped iron halide lamp.

According to yet another embodiment of the invention, the solid substrate is selected from the group consisting of silicon dioxide, glass, quartz, aluminum oxide, in particular sapphire, indium tin oxide, ceramics, mica, brass, non-noble metals such as aluminum, steel, iron, tin, solder, titanium, magnesium, zinc, chrome, copper, nickel, silicon, cobalt, tantalum, zirconium and oxides and chalcogenides thereof, noble metals such as silver, gold, platinum, palladium, osmium, and alloys thereof, silver oxide, polymers such as epoxy resins, polyesters, poly(ethylene terephthalate), poly(ethylene naphthalate), poly(lactic acid), polyamides, polyurethanes, poly(vinylic) polymers, poly(vinyl alcohol), poly(vinyl actate), poly(vinylidene chloride), polyolefins, dienic polymers, poly(isoprene), poly(methacrylate)s, and poly(acrylate)s.

Further examples for solid substrates are noble metals, non-noble metals, and their metal oxides, including but not limited to aluminum, aluminum oxide, rubis, steel, iron, iron oxide, tin, tin oxide, solder, titanium, titanium oxide, magnesium, magnesium oxide, zinc, zinc oxide, chrome, chrome oxide, copper, copper oxide, brass, indium tin oxide, silver, silver oxide, nickel, gold, palladium, platinum, osmium, silicon, silicon oxide, cobalt, tantalum, zirconium, zirconium oxide, as well as their alloys and composites, ceramics, glasses, thermoplastic polymers, elastomers, cross-linked polymers, resins, and nanocomposites, for instance epoxies used in microelectronics.

According to another embodiment of the invention, the coating layer on the solid substrate has a thickness of from 0.1 to 500 nm, particularly from 0.1 to 250 nm, more particularly from 0.1 to 100 nm or from 0.2 to 50 nm or from 0.3 to 30 nm or from 0.5 to 10 nm. A coating layer with a thickness of less than 0.1 nm did not have good properties in desired applications such as for example as barrier layer. Thick coating layers, in particular with a thickness of more than 500 nm were found to be too brittle for most applications.

According to another embodiment of the invention, the coating layer on the solid substrate comprises an atomically dense carbon layer. Preferably, the carbon layer results from a carbonization reaction of the oligoyne moieties of the monomers. Particularly, the atomically dense carbon layer contains 75 to 90% sp² hybridized carbon atoms and 25 to 10% sp³ hybridized carbon atoms. Advantageously, the head moieties and/or the tail moieties of the monomers are not affected by the carbonization reaction. Preferably, the coating comprises the head moieties and/or the tail moieties. The head moieties R and/or the tail moieties R′ are preferably attached to the carbon layer, thereby forming the coating layer. Particularly, the head moieties R and/or the tail moieties R′ are attached to the atomically dense carbon layer via the sp³ hybridized carbon atoms. Advantageously, the carbon layer has a carbon density from 1 to 2 g/cm³.

According to yet another embodiment of the invention, the oligoyne moieties (C≡C)ₙ of the monomers serve as reactive precursors for the formation of two-dimensional, atomically dense carbon monolayers. Monomers with oligoyne moieties (C≡C)ₙ, wherein n is 6, 7, or 8, are preferred since for these monomers, the number of carbon atoms in the oligoyne moiety can match well the number of carbons required to densely cover an area that corresponds to the molecular area occupied by a typical alkyl-terminated surfactant depending on the size of its head moiety.

According to yet another embodiment of the invention, in an additional step before inducing the reaction between oligoyne moieties, a layer of an additional solid substrate is deposited on the film. This can be helpful for the preparation of sandwich structures.

According to a further embodiment of the invention, in an additional step after inducing the reaction between oligoyne moieties, a layer of an additional solid substrate is deposited on the coating layer. This can be helpful for the preparation of sandwich structures.

The invention also relates to a coating obtainable by the method of the invention.

The details concerning the methods described herein are respectively also valid for the details concerning the coating obtainable according to the method of the invention. In particular the details concerning the binding, particularly the specific binding, of the head moieties to the substrate are also valid for the coating obtainable according to the method of the invention.

According to an embodiment of the invention, the coating has wear-resistant properties, anti-corrosive properties, protein-repellent properties, hydrophobic properties and/or oleophobic properties. The coating may also have the properties of biocompatibility or sensing of volatile organic compounds. These properties allow to tailor the properties of a surface in the way they are needed.

By employing the present invention, an effective coating can be obtained without using the otherwise required and significantly more expensive vapor-phase processes such as physical vapor deposition, chemical vapor deposition, or atomic layer deposition. Another advantage of the coating obtained by the method according to the invention is that the resulting coating can exhibit a defined and controlled surface coverage with chemical functional groups resulting from the head moieties and/or the tail moieties of the monomers that provide the possibility for a specific binding to the surface of the substrate to which they are applied, or to subsequent materials layers, or that can be used to introduce additional functions or properties.

According to another embodiment of the invention, the coating comprises a two-dimensional, extensively cross-linked, and atomically dense carbon monolayer. Preferably, this two-dimensional, extensively cross-linked, and atomically dense carbon monolayer has superior barrier properties against the diffusion of molecules or ions, comparable to those of atomically dense layers obtained by vapor deposition processes. Advantageously, the atomically dense carbon monolayers have defined moieties on either of their sides, because the moieties attached to the oligoyne moiety, that is the moieties R—(N)ₓ-(L)ₘ- and/or -(L′)ₒ-(N′)_{y}—R′, can remain attached to the carbon monolayers. The moieties on the sides of the atomically dense carbon monolayers can be the same or different. This can particularly aid in providing good adhesion to the solid substrate by, for example, specific binding or covalent attachment or strong physical absorption, and/or to other material layer that can be deposited on top of the carbon monolayers. This can result in good tribological properties and/or resistance against wear, lift-off, or delamination of the carbon monolayer. The moieties on the top side of the coating can serve as a means to provide additional functions or properties to the material, such as hydrophobicity, oleophobicity, hydrophilicity and/or biocompatibility, as well as sensing properties.

The invention also relates to the use of a coating obtainable according to the methods of the invention to control the wettability and/or to increase the corrosion resistance of components in machine building and/or precision mechanics.

The coating prepared by the method according to the invention may provide an atomically dense barrier layer. This barrier layer may have a low permeability for molecules and/or ions. The coating may, for example, be used as a barrier layer to reduce or prevent the diffusion of gases including oxygen, water, carbon dioxide, volatile organic compounds (VOCs), and/or ions. The coating may for example be used in two different types of applications, that is, anticorrosive coatings and packaging or encapsulation materials for food items, pharmaceuticals, and/or microelectronic devices.

For anticorrosive coatings and packaging or encapsulation materials, a coating may, for example, be applied as described herein to the surface of the employed substrate, selected from the group consisting of noble metals, non-noble metals, metal oxides, glasses, ceramics, thermoplastic polymers, elastomers, or organic materials. For this purpose, the coating can be chosen such that it provides specific binding to the surface, with the goal to prevent the removal or degradation of the coating by delamination, crack formation, lift-off, and/or wear. The coating on the surface itself may provide an atomically dense barrier towards the diffusion of molecules and/or ions, including but not limited to oxygen, water, other (reactive) gases, acids, bases, reductants, oxidants, ions, organic solvents and reactants, or etching solutions; but also biomolecules, bacteria, or fungi. Moreover, the coating may provide additional protection against the environment, by way of the moieties not used for the surface attachment. Coatings equipped with alkyl chains may, for example, provide hydrophobic properties and/or additional protection against diffusion of polar compounds, including water and carbon dioxide, to the substrate. These effects may be caused by frustration of surface interactions.

For example, a coating that carries perfluorinated alkyl moieties on the surface may, in addition, be oleophobic. Such a coating may frustrate the wetting of the covered surface with both hydrophobic and hydrophilic molecules and may thus provide an additional protection against diffusion of various types of small molecules. By contrast, coatings that carry hydrophilic oligo(ethylene glycol) moieties may have improved wettability in contact with an aqueous environment. Such coatings may, for example, also provide an improved biocompatibility by preventing the unspecific adsorption of biomolecules. In all examples, the additional surface-exposed moieties may provide all advantages of respective self-assembled monolayers, but they may be collectively bound to the solid substrate by a large number of surface-active moieties, so that this surface functionalization may have improved wear resistance.

In another exemplary use, the tail moieties of a coating may be used for a specific binding to additional coatings, so that the coating may serve as both an atomically dense diffusion barrier with excellent binding to the surface, and as a primer to ensure adhesion to further layers. For example, the above-described steel slide with a coating that is specifically bound to the surface by the phosphonic acid head moieties wherein the coating also has dodecyl moieties on its surface may have an enhanced resistance against corrosion. The corrosion protection properties of these coatings may be evaluated by means of electrochemical impedance spectroscopy. The anticorrosion properties may be further improved by the application of an additional, specifically bound layer of polymerized SU-8, as described above. Similarly, coatings with triethoxysilane head moieties may be used to improve the anticorrosion properties of aluminum substrates.

The invention also relates to a solid substrate comprising a coating obtainable by the methods according to the invention.

With the method according to the invention sandwich structures may also be prepared. These sandwich structures may comprise one or multiple coating layers on a substrate in combination with further layers of different materials selected from the group consisting of noble metals, non-noble metals, metal oxides, metal chalcogenides, glasses, ceramics, thermoplastic polymers, elastomers, or organic materials. In sandwich structures, the head moieties and tail moieties on the two faces of the coating layer or coating layers can be the same or different. For example, the head moieties and tail moieties may be selected such that they provide specific binding to both of the possibly different layers of solid substrate below and above. Therefore, sandwich structures with the same type of material in the layers below and above the coating layers may be prepared from monomers of the type R—(N)ₓ-(L)ₘ-(C≡C)ₙ-(L′)ₒ-(N′)_{y}—R′ in which the head moiety R and the tail moiety R′ are identical. The monomers may also be symmetric. Sandwich structures comprising different material layers above and below the coating layers may be prepared using unsymmetric monomers of the type R—(N)ₓ-(L)ₘ-(C≡C)ₙ-(L′)ₒ-(N′)_{y}—R′ in which the head moiety R and the tail moiety R′ are different.

For the preparation of such sandwich structures, for example, monomer films in the form of a monolayer or multilayer of the monomers of the type R—(N)ₓ-(L)ₘ-(C≡C)ₙ-(L′)ₒ-(N′)_{y}—R′ specifically bound to a solid substrate can be prepared using one of the methods described above. Then, an additional material's layer can be deposited on top of the monomer film by appropriate methods depending on the nature of the material. Appropriate methods for this deposition may include for example wet-chemical processes such as painting, spraying, coating, dipping, immersion, or casting techniques (e.g., for additional polymer layers), or vapor deposition techniques (e.g., for metals or metal oxides). The sandwiched monomer film can then be converted into a coating layer by exposure to irradiation and/or thermal annealing and/or by a chemical radical initiator as previously described.

Alternatively, a monomer film specifically bound to a solid substrate can be first converted into a coating layer by exposure to irradiation and/or thermal annealing and/or by a chemical radical initiator as previously described, and then the second material's layer can be deposited on top by using the appropriate methods depending on the nature of the material, as described above. After exposure to irradiation and/or thermal annealing and/or a chemical radical initiator and before deposition of the second materials layer, one or several other coating layers may be applied on top of the first coating layer by applying a monomer film on the coating layer which can be exposed to irradiation and/or thermal annealing and/or a chemical radical initiator, which may be repeated.

In these sandwich structures, the specific binding to the substrate and the specific binding to the layer deposited on top of the coating may involve additional chemical reactions between the head moieties R and/or tail moieties R′ of the monomer or the coating layer with appropriate chemical functional groups in the deposited material.

For example, a coating layer with phosphonic acid head moieties bound to a steel substrate and hydroxyl tail moieties on the second face may provide specific binding for an epoxy based polymer such as SU-8. The coating layer may serve as a primer to ensure adhesion to the steel substrate as well as to the epoxy topcoat through specific binding towards both materials.

Another example is the use of coating layers as an additional barrier layer in laminates of standard packaging polymers that may provide additional, specific adhesion between the layers. For example, one or several coating layers with epoxide head moieties bound to a PET substrate and epoxide tail moieties on the second face may provide specific binding for another PET layer on top. Moreover, a PET substrate covered with one or several coating layers that have carboxylic acid tail moieties on the second face may provide specific binding for a poly(vinyl alcohol) layer on top. The combination of different types of one or several coating layers may be possible by consecutive transfer. For example, a coating layer that may have been prepared from a monomer film in the form of a multilayer with phosphonic acid head moieties bound to a steel substrate and hydroxyl tail moieties on the second face that can provide specific binding to a coating layer with epoxide head moieties that also carries perfluoroalkyl chains as tail moieties on the second face. In this way, a coating comprising multiple coating layers with specific binding between the coating layers can be provided that moreover can provide oleophobic properties. Such a multilayer system can also be beneficial to address defects in the coating layer and may reliably cover larger substrates. For example, a coating layer with epoxide head moieties bound to a PET substrate and epoxide tail moieties on the second face may provide specific binding to a coating layer with hydroxyl head moieties that also carries hydroxyl tail moieties on the second face providing adhesion to a top layer of poly(vinyl alcohol).

Furthermore, this approach may be extended to the formation of hybrid inorganic/organic multilayers, by way of chemical reactions of the moieties at the exposed surface of the coating layers with other suitable compounds. For example, a coating layer with either hydroxyl or trialkoxysilane moieties on the surface can initiate a reaction with silica precursors such as orthosilicates, leading to the formation of a silicate or amorphous silica layer covering the coating layer. A similar approach can also lead to the formation of a layer of a metal chalcogenide. For example, a coating layer with exposed thiol functional groups on the surface can be used as the substrate for the surface initiated growth of a layer of a hybrid with molybdenum disulfide.

The invention also relates to the use of a solid substrate comprising a coating obtainable by the methods according to the invention as a barrier layer in food packaging, pharmaceutical packaging, and/or encapsulation of electronic devices. The details concerning the use of the coating layer described herein are also valid for the details concerning the solid substrate comprising a coating.

For example, the barrier properties of substrates covered with the coatings may be measured by means of coulometric and/or electrolytic gas permeation measurements. For example, a coating with epoxide head moieties bound to a PET substrate and dodecyl chains as tail moieties on its surface may be used as a barrier layer in food packaging and/or pharmaceutical packaging and/or encapsulation of devices. Another example for a barrier layer may be obtained by deposition of an additional PET layer on top of this substrate comprising a coating to produce a sandwich structure in which the coating is specifically bound to both PET layers. For example, laminates comprising combinations of the coatings with specific binding to layers of PEN, poly(ethylene), poly(propylene), poly(vinyl alcohol) and combinations thereof can be used for barrier layers for the use in food packaging and/or pharmaceutical packaging and/or encapsulation of devices.

For example, preferred materials for encapsulation of microelectronics include PEN and PET, while preferred materials for packaging of foods include paper, cardboard, aluminum, aluminum oxide, silicon oxide, and synthetic polymers such as polyolefins (poly(propylene), high-density poly(ethylene), low-density poly(ethylene)), polyamides, poly(vinyl alcohol), PET and poly(lactic acid), and combinations thereof. Particularly effective for encapsulation of microelectronics and/or for the packaging of foods are laminates. An example of a laminate can comprise a PET layer and a heat-sealable polyolefin-based layer, and a coating according to the invention. The heat-sealable layer can be preferably made of poly(ethylene), and preferably low-density poly(ethylene) or linear low-density poly(ethylene). The coating according to the invention can for example be prepared on the PET layer as described herein or a coating can be transferred to the PET layer from a different solid substrate by one of the herein described methods. For enhanced adhesion of the coating the surface of the PET layer may be altered using adequate surface modification such as corona-discharge. The PET layer coated with the coating can be subsequently laminated with the heat-sealable layer using suitable adhesive bonding, such as hot-melt adhesives. For enhanced adhesion between the layers, the surface of the heat-sealable layer may also be altered using e.g. corona-discharge.

### DESCRIPTION OF FIGURES

In the drawings,

FIG. 1 shows a scheme of an exemplary procedure for bringing monomers into contact with a solid substrate;

FIG. 2 shows a scheme of another exemplary procedure for bringing monomers into contact with a solid substrate;

FIG. 3 shows a scheme of a an exemplary procedure for inducing a reaction between oligoyne moieties;

FIG. 4 shows a scheme with different exemplary procedures for the preparation of sandwich structures;

FIG. 5a shows an example of a coating comprising several coating layers;

FIG. 5b shows an example of a laminated structure;

FIG. 5c shows an example of a laminated sandwich structure;

FIG. 6 shows a coating obtained on a solid substrate;

FIG. 7 shows UV-Vis spectra of a film of monomers on sapphire and of a coating obtained therefrom;

FIG. 8 shows a graph of the determination of the oxygen transmission rate (OTR) of Arylite® foils and of Arylite® foils with a coating according to the invention.

FIG. 9 shows an X-ray Photoelectron spectrum of an uncoated iron reference substrate.

FIG. 10 shows an X-ray Photoelectron spectrum of an iron substrate with a coating according to the invention.

FIG. 1 shows an example for a procedure that can be employed to bring the monomers 1 into contact with the solid substrate. In this exemplary procedure, the monomers 1 are first spread at the air-water interface which brings the head moieties 3 in contact with the aqueous phase 4. The tail moieties 2 point away from the air-water interface. The monomers 1 are then transferred onto a solid substrate 5 such that the head moieties 3 are in contact with the solid substrate 5 and the tail moieties 2 point away from the solid substrate 5.

FIG. 2 shows an example for a procedure that can be employed to bring the monomers 1 into contact with the solid substrate. In this exemplary procedure, a solution of the monomers 1 having head moieties 3 and tail moieties 2 in a solvent 6 is applied to a solid substrate 5. The monomers 1 align on the substrate such that the tail moieties 2 point away from the solid substrate 5, and the head moieties 3 are in contact with the solid substrate.

FIG. 3 shows an example for a procedure to induce a reaction between oligoyne moieties thereby at least partially cross-linking the monomers 1. In this exemplary procedure, monomers 1 are in contact with solid substrate 5 via the head moieties 3 of the monomers 1 while the tail moieties 2 point away from the solid substrate 5. The monomers 1 form a film in which the oligoyne moieties of the monomers 1 are in close contact with each other. Application of a mild external stimulus such as, for example, heat or irradiation, induces a reaction between the oligoyne moieties to form a coating layer 7.

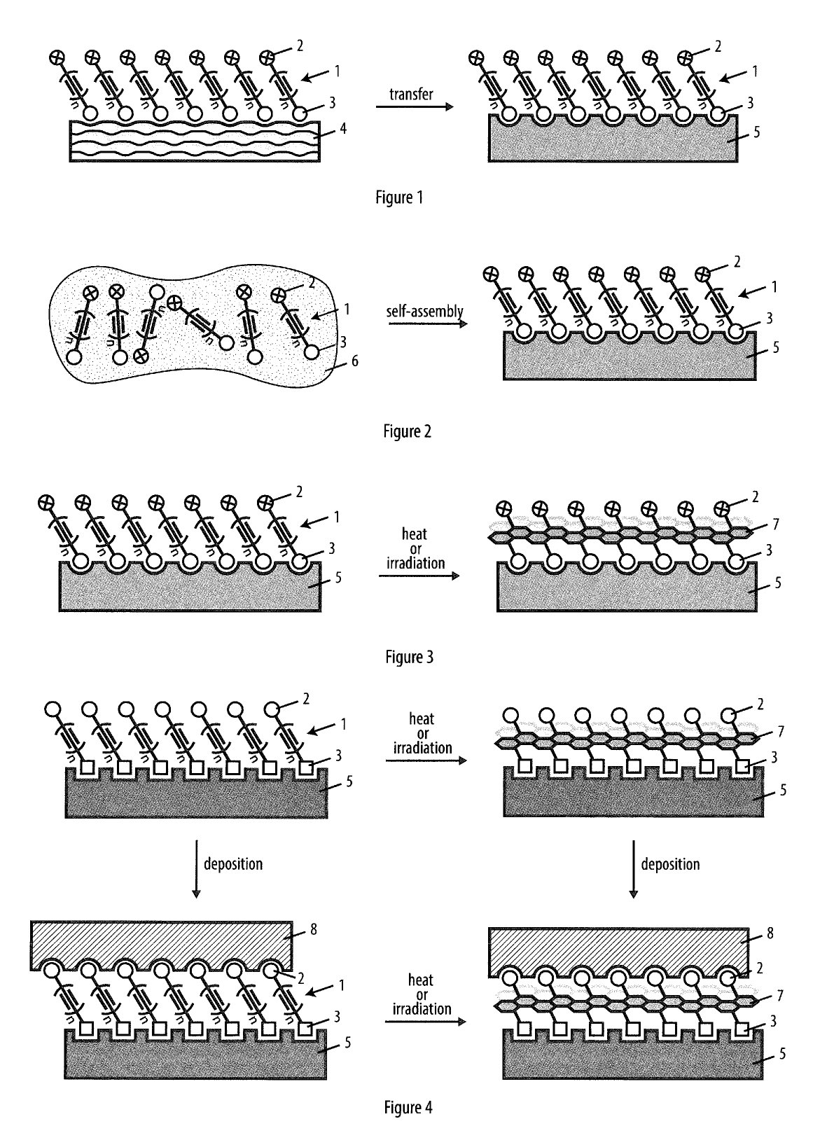

FIG. 4 shows different examples for the preparation of sandwich structures. In these exemplary procedures, monomers 1 are in contact with solid substrate 5 via the head moieties 3 of the monomers 1 while the tail moieties 2 point away from the solid substrate 5 thereby forming a film. Subsequently, an additional layer of a different solid substrate 8 is applied to the film such that tail moieties 2 of monomers 1 are in contact with the additional layer of solid substrate 8. Application of a mild external stimulus such as, for example, heat or irradiation, induces a reaction between the oligoyne moieties to form a coating layer 7. Alternatively, a reaction between oligoyne moieties can be induced in the film of the unreacted monomers 1 on solid substrate 5 by application of an external stimulus such as, for example, heat or irradiation before an additional layer of a solid substrate 8 is applied. Due to the external stimulus, a coating layer 7 is formed. Subsequently, an additional layer of a solid substrate 8 can be applied.

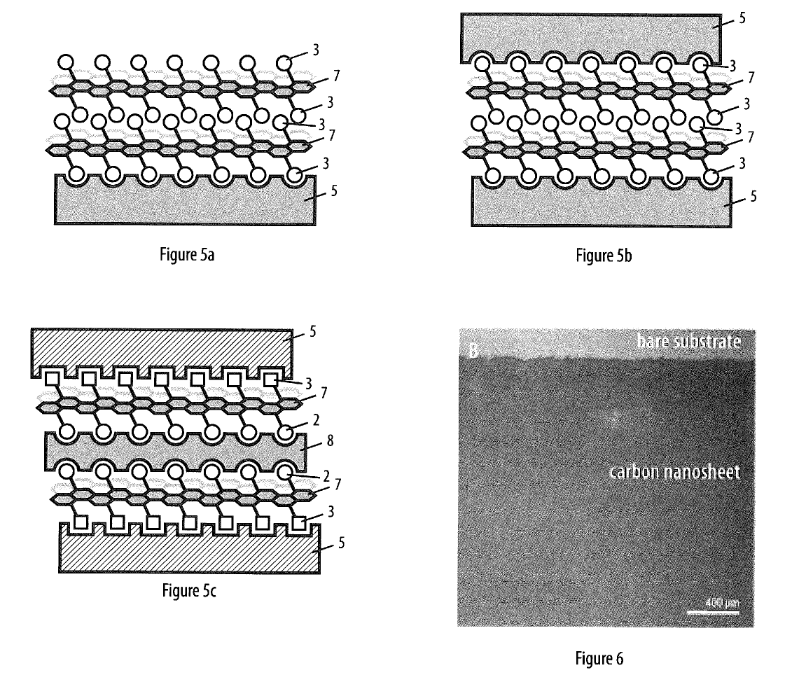

FIG. 5a shows an example of a solid substrate 5 with a coating comprising two coating layers 7. The coating layers comprise identical head and tail moieties 3.

FIG. 5b shows an example of a laminated structure obtained from a solid substrate 5 comprising a coating layer 7 with identical head and tail moieties 3 in which adhesion inside the laminate is achieved via the tail moieties 3 of the coating layers 7.

FIG. 5c shows an example of a laminated structure containing two solid substrates 5 each comprising a coating layer 7 that is in contact with the respective solid substrate 5 via its head moieties 3. Via its tail moieties 2, the coating layers 7 are in contact with a layer of an additional solid substrate 8.

FIG. 6 shows a micrograph of a coating layer on a solid substrate obtained in Example 8. The coating layer can be seen as the darker area, and solid substrate without a coating layer can be seen as the lighter area at the top of the Figure.

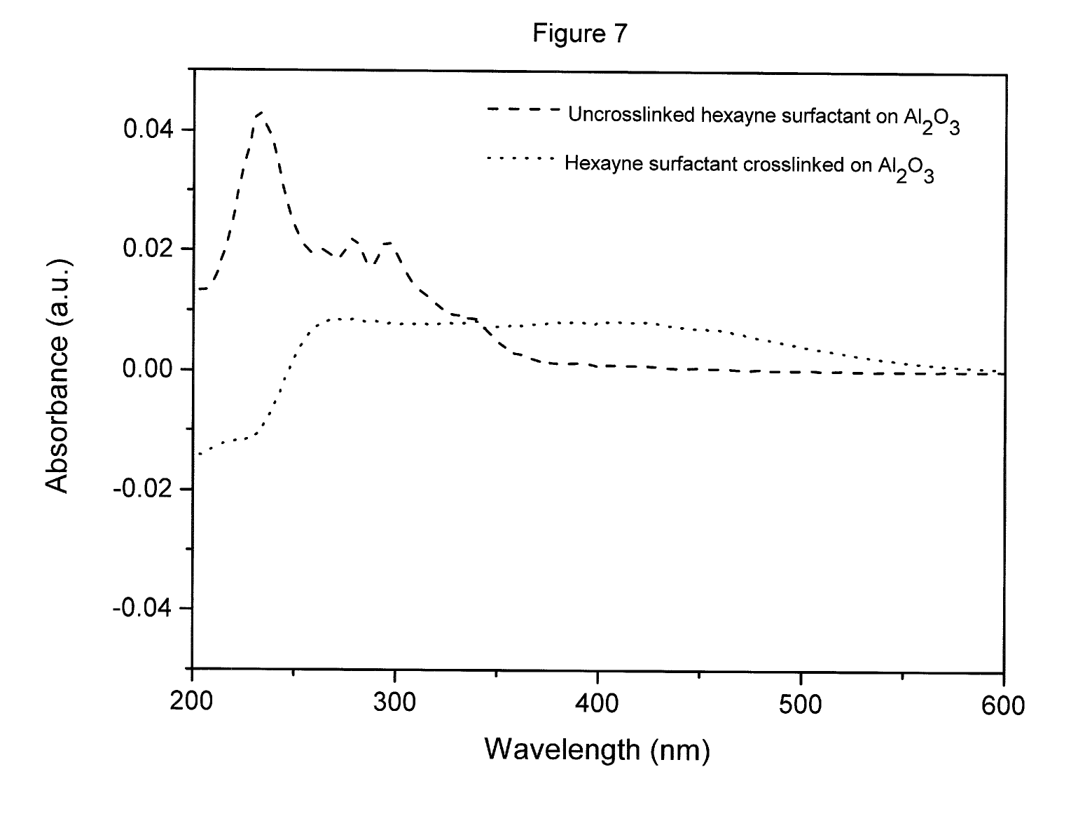

FIG. 7 shows UV-Vis spectra of a film of octacosa-5,7,9,11,13,15-hexaynoate monomers transferred from the air-water interface to a sapphire substrate (dashed curve). FIG. 7 also shows a coating according to the invention obtained by UV irradiation of a film of octacosa-5,7,9,11,13,15-hexaynoate monomers on a sapphire substrate.

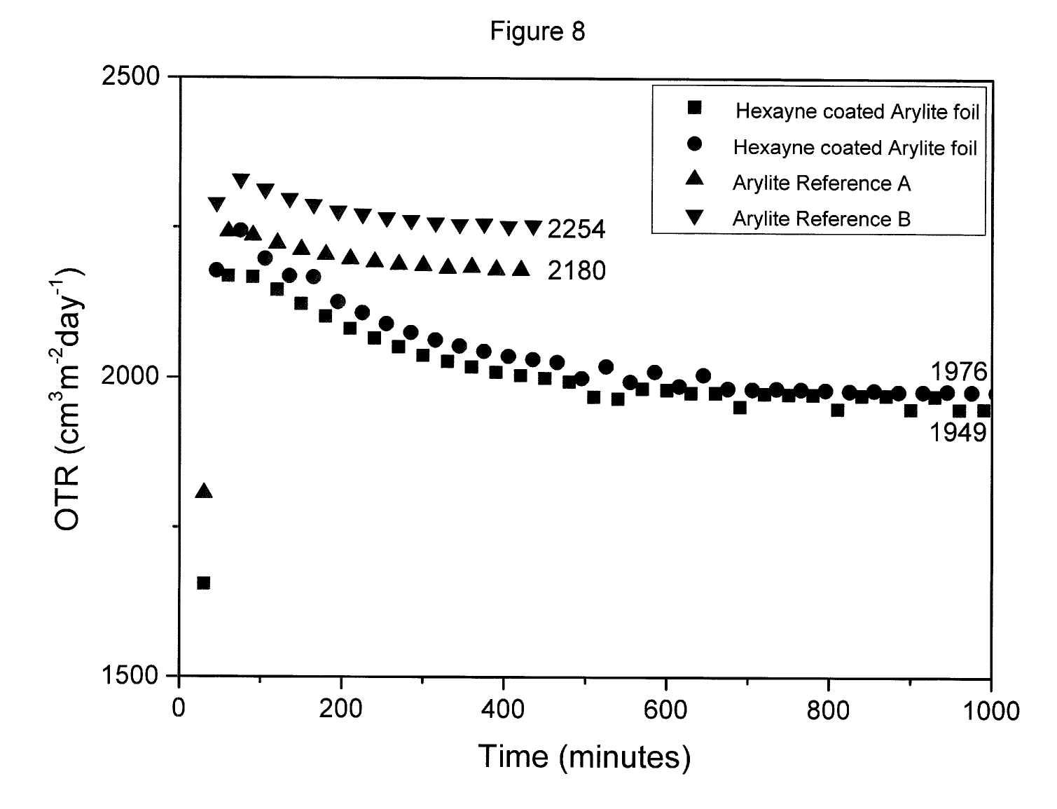

FIG. 8 shows the determination of the Oxygen Transmission Rate (OTR) of uncoated Arylite® reference foils and of Arylite® foils with a coating according to the invention obtained by UV irradiation of a film of octacosa-5,7,9,11,13,15-hexaynoate monomers on the Arylite® foil.

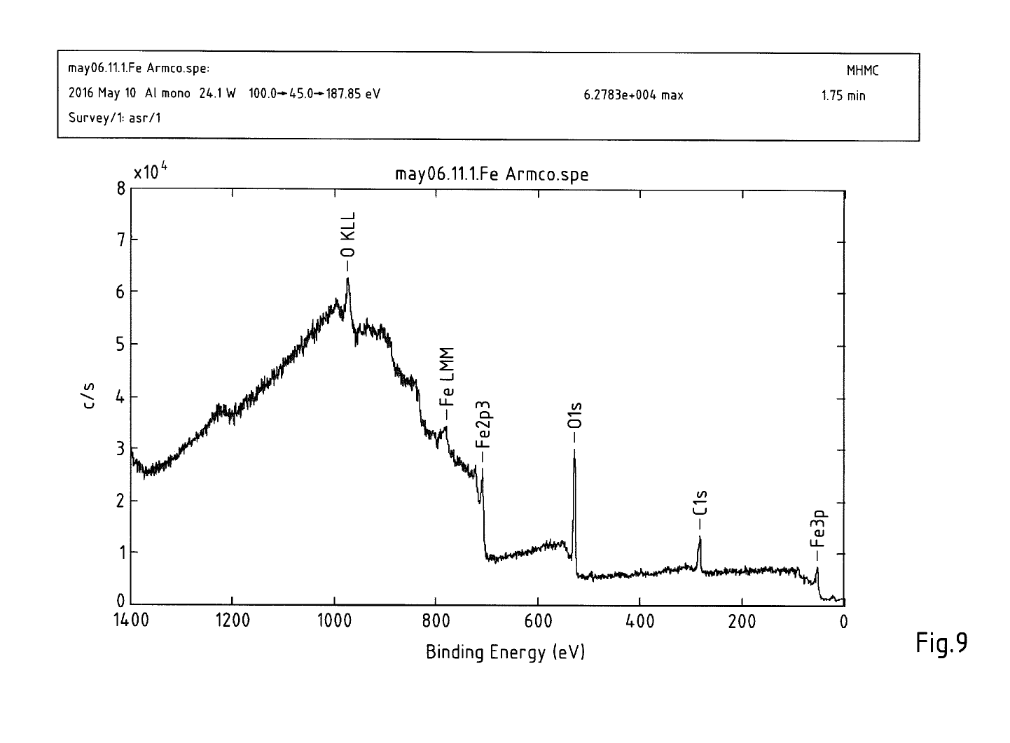

FIG. 9 shows an X-ray Photoelectron spectrum of an uncoated iron reference substrate. The spectrum shows a minor peak for carbon.

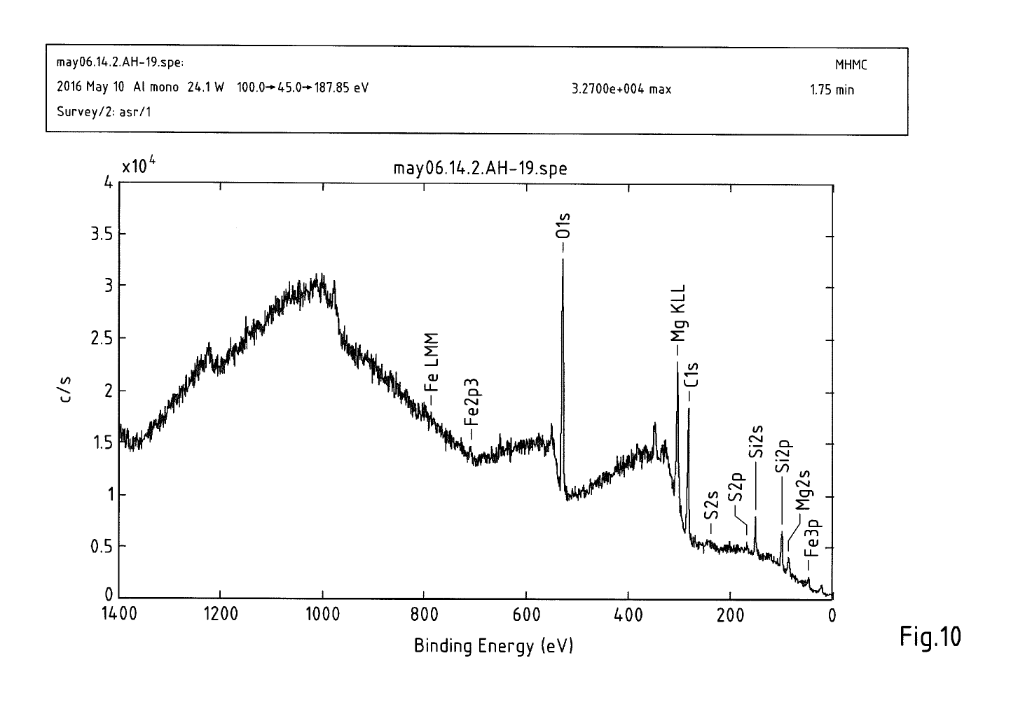

FIG. 10 shows an X-ray Photoelectron spectrum of an iron substrate with a coating according to the invention obtained by UV irradiation of a film of octacosa-5,7,9,11,13,15-hexaynoate on an iron substrate. The spectrum shows a pronounced peak for carbon.

### EXAMPLES

In the following, the invention shall be explained in further detail using specific examples which are not to be construed as limiting in any way.

Chemicals and Materials:

Deuterated solvents (deuterated chloroform, CDCl₃, deuterated dimethylsulfoxide, DMSO-d₆) were purchased from Cambridge Isotope Laboratories, Inc. and Armar Chemicals. The TLC analyses were performed on TLC plates from Merck (Silica gel 60 F254). UV-light (366 or 254 nm) as well as anisaldehyde staining reagent were used for the visualization and detection of the samples. Purification by column chromatography was carried out with silica gel (Si 60, 40-60 μm) from Merck. Solvents used for column chromatography were purchased as reagent grade (Reactolab) and distilled once prior to use. Unless otherwise noted, all reactions were carried out in dried Schlenk glassware in an inert argon atmosphere, and all reagents were commercially obtained as reagent grade and used without further purification. Solvents were purchased as reagent grade and distilled once prior to use. For reactions in dry conditions, acetonitrile (MeCN), dichloromethane (DCM), tetrahydrofuran (THF), and toluene were purchased as HPLC grade (Fisher Chemicals) and dried as well as degassed using a solvent purification system (Innovative Technology, Inc., Amesbury, Mass., USA). Diethylether and methanol (MeOH) were purchased dry over molecular sieves (Acros Organics). Otherwise purchased chemicals were used as received from the following suppliers: silver fluoride (Fluorochem), sodium methanolate (NaOMe) (Acros), chloroform (VWR International), triethylene glycolmonomethylether (Fluka), sodium hydroxide (Sigma-Aldrich), 1,4-dioxane (Sigma-Aldrich), lithium hydroxide (Fluka), copper bromide (Acros), Amberlite IR-120 (H+) (Fluka), N,N,N′,N′-tetramethylethane-1,2-diamine (Acros), hydrochloric acid (Reactolab), sodium chloride (VWR International), sodium sulfate (VWR International). All starting compound for the described syntheses were prepared according to standard literature procedures. The following equipment for the preparation of nanolayers and the transfer of molecular nanolayers as well as carbon nanolayers was used: Langmuir trough (R&K Potsdam), thermostat (E1 Medingen), Hamilton syringe Model 1810 RN SYR (BGB Analytik), UV lamp (250 W, Ga-doped metal halide bulb) (UV-Light Technology), holey carbon TEM grids (Electron Microscopy Sciences), silicon wafers (custom made EPFL cleanroom), Platinum-coated wafer (Bruker), scanning electron microscope (Zeiss), optical microscope (Olympus), filter paper Wilhelmy plate (VWR International).

For additional procedures, in particular for the preparation of some of the compounds described in the Examples, see, for example, Schrettl, Chem. Sci, 2015, 6, 564, Szilluweit, Nano Lett. 2012, 12, 2573, Schrettl, Nature. Chem. 2014, 6, 468, Frauenrath, Org. Lett. 2008, 10, 4525.

Monomer Preparation:

### Example 1 (Monomer 1, Methyl 16-(triisopropylsilyl)hexadeca-5,7,9,11,13,15-hexaynoate)

In a flask shielded from light with aluminum foil 4-tritylphenyl-16-(triisopropylsilyl)hexadeca-5,7,9,11,13,15-hexaynoate (240 mg, 0.340 mmol) was dissolved in dichloromethane (DCM) (5 mL) and MeOH (1 mL). NaOMe (65 mg, 0.833 mmol) was added, and the resulting mixture was stirred for 5 hours. Then, Amberlite IR-120 (H+) was added until the solution was neutralized, and the resulting mixture was stirred for 1 hour. The solution was filtered from the Amberlite and transferred into a brown glass vial using a syringe with a fine needle. The crude compound was purified by column chromatography (silica gel; DCM). Freeze-drying yielded methyl 16-(triisopropylsilyl)hexadeca-5,7,9,11,13,15-hexaynoate as a yellow oil that was immediately redissolved in dioxane/MeOH and stored in the refrigerator. ¹H NMR (400 MHz, CDCl₃) δ 3.68 (s, 3H), 2.43 (dt, J=7.0 Hz, 4.8 Hz, 4H), 1.88 (p, J=7.1 Hz, 2H), 1.09-1.01 (m, 21H). ¹³C NMR (101 MHz, CDCl₃) δ=173.5, 89.9, 87.3, 81.0, 69.9, 63.3, 63.2, 62.9, 62.9, 62.7, 62.1, 61.8, 61.2, 52.2, 33.0, 23.5, 19.5, 19.0, 11.7. R_{f}: 0.83 (dichloromethane).

### Example 2 (Monomer 2, Dimethyl icosa-5,7,9,11,13,15-hexaynedioate)

In a flask shielded from light with aluminum foil 4-tritylphenyl-10-(trimethylsilyl)deca-5,7,9-triynoate (318 mg, 0.545 mmol) was dissolved in DCM (15 mL) and MeCN (10 mL) as well as AgF (83.5 mg, 0.572 mmol) were added. The mixture was stirred for 10 minutes, CuBr₂ (133.7 mg, 0.599 mmol) and N,N,N′,N′-tetramethylethane-1,2-diamine (0.18 mL, 1.19 mmol) were added, and stirring was continued for 2 hours. The mixture was diluted with MeOH (10 mL) and NaOMe (136.2 mg, 2.18 mmol) was added. The reaction was stirred for 1 hour, diluted with DCM, washed twice with 1M HCl and once with saturated NaCl solution. The organic phase was dried over Na₂SO₄ and concentrated in vacuo. Column chromatography (silica gel; CHCl₃) yielded dimethyl icosa-5,7,9,11,13,15-hexaynedioate as a yellow solution. For analytical purposes, DMSO-d₆ (10 mL) was added, and the mixture was concentrated in vacuo. ¹H NMR (400 MHz, DMSO-d₆) δ=3.70 (s, 6H), 2.59 (t, J=7.1 Hz, 4H), 2.49 (t, J=7.3 Hz, 4H), 1.89 (p, J=7.2 Hz, 4H). ¹³C NMR (101 MHz, DMSO-d₆) δ=172.25, 82.65, 65.12, 62.82, 62.08, 60.95, 59.60, 51.16, 31.99, 22.59, 18.12. R_{f}: 0.22 (CHCl₃).

### Example 3 (Monomer 3, 16-(triisopropylsilyl)hexadeca-5,7,9,11,13,15-hexaynoic acid)

In a flask shielded from light with aluminum foil methyl 16-(triisopropylsilyl)hexadeca-5,7,9,11,13,15-hexaynoate (280 mg, 0.69 mmol) was dissolved in THF (5 mL) and MeOH (5 mL), water (5 mL), as well as LiOH (30 mg, 1.2 mmol) were consecutively added. The mixture was stirred for 2 hours at room temperature and Amberlite IR-120 (H+) was added until the solution was neutralized, and the resulting mixture was stirred for 30 min. The mixture was filtered, diluted with DCM, washed once with 1M HCl and once with saturated NaCl solution. The organic phase was dried over Na₂SO₄ and concentrated in vacuo to yield 16-(triisopropylsilyl)hexadeca-5,7,9,11,13,15-hexaynoic acid as a concentrated yellow solution.

### Example 4 (Monomer 4, icosa-5,7,9,11,13,15-hexaynedioic acid)

In a flask shielded from light with aluminum foil dimethyl icosa-5,7,9,11,13,15-hexaynedioate (120 mg, 0.35 mmol) was dissolved in THF (5 mL) and MeOH (5 mL), water (5 mL), as well as LiOH (30 mg, 1.2 mmol) were consecutively added. The mixture was stirred for 2 hours at room temperature and Amberlite IR-120 (H+) was added until the solution was neutralized, and the resulting mixture was stirred for 30 min. The mixture was filtered and concentrated in vacuo to yield icosa-5,7,9,11,13,15-hexaynedioic acid as a concentrated yellow solution.

### Example 5 (Monomer 5, Triethylene glycolmonomethylether 16-(triisopropylsilyl)hexadeca-5,7,9,11,13,15-hexaynoic acid ester)

In a flask shielded from light with aluminum foil 4-tritylphenyl-16-(triisopropylsilyl)hexadeca-5,7,9,11,13,15-hexaynoate (240 mg, 0.34 mmol) was dissolved in DCM (5 mL) and 1,4-dioxane (1 mL). Sodium triethyleneglycolmonomethylether (112 mg, 0.6 mmol) was added, and the resulting mixture was stirred for 5 hours. Then, Amberlite IR-120 (H+) was added until the solution was neutralized, and the resulting mixture was stirred for 1 hour. The solution was filtered from the Amberlite and transferred into a brown glass vial using a syringe with a fine needle. The crude compound was purified by column chromatography (silica gel; DCM:methanol 40:1). The product fractions were concentrated in vacuo to yield triethylene glycolmonomethylether 16-(triisopropylsilyl)hexadeca-5,7,9,11,13,15-hexaynoic acid ester as a concentrated yellow solution.

### Example 6 (Monomer 6, Bis(triethylene glycolmonomethylether) icosa-5,7,9,11,13,15-hexaynediacid diester)

In a flask shielded from light with aluminum foil dimethyl icosa-5,7,9,11,13,15-hexaynedioate (180 mg, 0.52 mmol) was dissolved in DCM (5 mL) and 1,4-dioxane (1 mL). Sodium triethyleneglycolmonomethylether (230 mg, 1.2 mmol) was added, and the resulting mixture was stirred for 4 hours. Then, Amberlite IR-120 (H+) was added until the solution was neutralized, and the resulting mixture was stirred for 30 min. The solution was filtered from the Amberlite and transferred into a brown glass vial using a syringe with a fine needle. The crude compound was purified by column chromatography (silica gel; DCM:methanol 20:1). The product fractions were concentrated in vacuo to yield bis(triethylene glycolmonomethylether) icosa-5,7,9,11,13,15-hexaynediacid diester as a concentrated yellow solution.

### Preparation of Coatings

### Example 7 (Preparation and Transfer of Monomer Films to Solid Substrates)

Transfer of the monomer film from the air-water interface to a silicon wafer was achieved by the Langmuir-Blodgett technique using a computer-interfaced polytetrafluoroethylene Langmuir trough equipped with two barriers and a surface pressure microbalance with a filter paper Wilhelmy plate. All substrates were cleaned and stored in Millipore water prior to use. Tweezers attached to a mechanical arm were placed vertically above the Langmuir trough. Held by the tweezers, the silicon wafers with a native layer of silicon oxide were immersed in the subphase and the air-water interface was thoroughly cleaned before spreading of the molecular precursor. The film formation of the monomer methyl octacosa-5,7,9,11,13,15-hexaynoate at the air-water interface was achieved by spreading a dilute chloroform stock solution (c=1 mmol/L) on the surface of Millipore water in a polytetrafluoroethylene Langmuir trough equipped with two barriers and a surface pressure microbalance with a filter paper Wilhelmy plate was employed. Equilibration for 15 min allowed for the evaporation of the organic solvent. For the transfer, the film was compressed to a surface pressure of 8 mN/m at which the molecules were densely aggregated. The silicon wafer substrate was then slowly removed from the air-water interface by retreating the vertically aligned mechanical arm with a speed of 1.2 mm/min while keeping the surface pressure constant.

### Example 8 (Coating Layer Preparation on a Solid Substrate)

Monomer films of the precursor molecule methyl octacosa-5,7,9,11,13,15-hexaynoate were obtained by transfer from the air-water interface as described above. The carbonization of a monomer film on a silicon wafer with a native layer of silicon oxide to form a coating layer was achieved by a UV-induced cross-linking of the hexayne moieties. The UV lamp was placed so that the complete surface of the substrate was illuminated and irradiation was carried out for 40 min. See also FIG. 6.

### Preparation of Further Monomers

### Preparation of Intermediates for the Synthesis of Further Monomers

### Example 9 (Intermediate 1, 10-(trimethylsilyl)deca-5,7,9-triyn-1-yl 4-methylbenzenesulfonate)

MeLi.LiBr complex (2.68 mL, 2.2 M in Et₂O, 5.89 mmol) was added to 1,4-bis(trimethylsilyl)butadiyne (1.17 g, 6.04 mmol) in THF (20 mL) at 0° C. in an argon atmosphere, and the resulting mixture was stirred for 30 min. Then, ZnCl₂ (3.02 mL, 2 M in 2-methyltetrahydrofuran (MeTHF), 6.04 mmol) was added at 0° C., and the resulting mixture was again stirred for 30 min. In another flask, 6-bromohex-5-yn-1-yl 4-methylbenzenesulfonate (1.0 g, 3.02 mmol) and Pd(dppf)Cl₂.DCM (246 mg, 0.30 mmol) were mixed in toluene (100 mL). The two solutions were combined at 0° C., and the flask was wrapped with aluminium foil. The mixture was stirred for 20 h at room temperature. The dark mixture was then diluted with Et₂O, washed three times with saturated NH₄Cl solution and once with saturated NaCl solution. The organic phase was dried over Na₂SO₄ and concentrated in vacuum. Column chromatography (silica gel; gradient of eluent: from petrol ether/DCM 3:1 to petrol ether/DCM 1:1) yielded the product (0.94 g, 84%) as a light brown oil. ¹H NMR (400 MHz, CDCl₃): δ 7.79 (d, J=8.0 Hz, 2H), 7.36 (d, J=8.0 Hz, 2H), 4.05 (t, J=6.1 Hz, 2H), 2.46 (s, 3H), 2.28 (t, J=6.9 Hz, 2H), 1.78-1.71 (m, 2H), 1.62-1.54 (m, 2H), 0.20 (s, 9H). ¹³C NMR (101 MHz, CDCl₃): δ 144.99, 133.19, 130.04, 128.03, 88.32, 86.07, 79.67, 69.75, 66.38, 62.29, 60.51, 27.97, 24.06, 21.81, 18.95, −0.34.

### Example 10 (Intermediate 2, Diethyl (10-(trimethylsilyl)deca-5,7,9-triyn-1-yl)phosphonate)

MeLi.LiBr complex (13.0 mL, 2.2 M in Et₂O, 28.6 mmol) was added to 1,4-bis(trimethylsilyl)butadiyne (5.73 g, 29.5 mmol) in THF (40 mL) at 0° C. in an argon atmosphere, and the resulting mixture was stirred for 30 min. Then, ZnCl₂ (14.8 mL, 2 M in 2-methyltetrahydrofuran (MeTHF), 29.6 mmol) was added at 0° C., and the resulting mixture was again stirred for 30 min. In another flask, diethyl (6-bromohex-5-yn-1-yl) phosphonate (5.33 g, 17.9 mmol) and Pd(dppf)Cl₂.DCM (293 mg, 0.36 mmol) were mixed in toluene (200 mL). The two solutions were combined at 0° C., and the flask was wrapped with aluminium foil. The mixture was stirred for 20 h at room temperature. The dark mixture was then diluted with Et₂O, washed three times with saturated NH₄Cl solution and once with saturated NaCl solution. The organic phase was dried over Na₂SO₄ and concentrated in vacuum. Column chromatography (silica gel: eluent EtOAc/DCM 1:1) yielded the product (3.7 g, 61%) as a light brown oil. ¹H NMR (400 MHz, CDCl₃) δ 4.14-4.09 (m, 4H), 2.35 (t, J=6.5 Hz, 2H), 1.78-1.64 (m, 6H), 1.34 (t, J=7.0 Hz, 6H), 0.21 (s, 9H). ¹³C NMR (101 MHz, CDCl₃): δ 88.23, 85.70, 66.01, 62.28, 61.58, 61.51, 60.19, 28.71, 28.54, 25.85, 24.44, 21.79, 21.74, 19.08, 19.07, 16.51, 16.45, 0.48, 0.45. ³¹P NMR (162 MHz, CDCl₃) δ 31.45.

### Example 11 (Intermediate 3, 2,3,5,6-tetrafluorophenyl 10-(trimethylsilyl)deca-5,7,9-triynoate)

MeLi.LiBr complex (13.4 mL, 2.2 M in Et₂O, 14.75 mmol) was added to 1,4-bis(trimethylsilyl)butadiyne (5.88 g, 30.2 mmol) in THF (20 mL) at 0° C. in an argon atmosphere, and the resulting mixture was stirred for 30 min. Then, ZnCl₂ (15.1 mL, 2 M in 2-methyltetrahydrofuran (MeTHF), 30.3 mmol) was added at 0° C., and the resulting mixture was again stirred for 30 min. In another flask, 2,3,5,6-tetrafluorophenyl 6-bromohex-5-ynoate (5.0 g, 14.7 mmol) and Pd(dppf)Cl₂. DCM (1.20 g, 1.5 mmol) were mixed in toluene (100 mL). The two solutions were combined at 0° C., and the flask was wrapped with aluminium foil. The mixture was stirred for 20 h at room temperature. The dark mixture was then diluted with Et₂O, washed three times with saturated NH₄Cl solution and once with saturated NaCl solution. The organic phase was dried over Na₂SO₄ and concentrated in vacuum. Column chromatography (silica gel; heptane/DCM 1:1) yielded the product (3.4 g, 60%) as a crystalline solid. ¹H NMR (400 MHz, CDCl₃) δ 7.00 (m, 1H); 2.82 (t, J=7.6 Hz, 2H), 2.49 (t, J=6.8 Hz, 2H), 2.02 (p, J=6.8 Hz, 2H), 0.20 (s, 8H). ¹³C NMR (101 MHz, CDCl₃): δ 168.8, 103.4, 88.2, 86.3, 78.7, 67.0, 62.1, 60.8, 32.1, 23.2, 18.8, 0.4.

### Preparation of Further Monomers

### Example 12 (Monomer 7, Bis(2,3,5,6-tetrafluorophenyl) icosa-5,7,9,11,13,15-hexaynedioate)

2,3,5,6-tetrafluorophenyl 10-(trimethylsilyl)deca-5,7,9-triynoate (0.2 g, 0.526 mmol) was dissolved in a mixture of dry DCM (8 mL) and dry acetonitrile (8 mL). Silver fluoride (70 mg, 0.552 mmol) and copper(II) bromide were added, and the reaction mixture was stirred overnight at room temperature. The reaction mixture was then diluted with DCM, washed four times with 1 M HCL solution and one time with saturated NaCl solution. The organic phase was dried over Na₂SO₄ and concentrated in vacuum. Column chromatography (silica gel; pentane/DCM 2:1) yielded a solution of the product. ¹H NMR (400 MHz, CDCl₃) δ 7.00 (m, 2H), 2.82 (t, J=7.2 Hz, 4H), 2.52 (t, J=6.8 Hz, 4H), 2.04 (p, J=7.2 Hz, 4H). ¹³C NMR (101 MHz, CDCl₃): δ 168.7, 147.4, 144.9, 141.8, 139.3, 129.6, 103.5, 79.6, 67.0, 62.5, 62.5, 61.9, 61.2, 32.1, 23.1, 18.9.

### Example 13 (Monomer 8, Octacosa-5,7,9,11,13,15-hexayn-1-yl 4-methylbenzenesulfonate)

1) 10-(trimethylsilyl)deca-5,7,9-triyn-1-yl 4-methylbenzenesulfonate (630 mg, 1.69 mmol) was dissolved in acetonitrile (12 mL) and DCM (15 mL). The flask was shielded from light with aluminium foil, and N-bromosuccinimide (316 mg, 1.78 mmol) as well as AgF (225 mg, 1.78 mmol) were added. The resulting mixture was stirred for 4 h, after which it was diluted with DCM, filtered over Celite and washed twice with 1 M HCl solution and once with saturated NaCl solution. The organic phase was dried over Na₂SO₄ and concentrated in vacuum to a volume of approximately 10 mL while thoroughly shielding it from light. Dry toluene was added (10 mL), the mixture was concentrated in vacuum, and this solution containing 10-bromodeca-5,7,9-triyn-1-yl 4-methylbenzenesulfonate was used without further purification in the next step.

2) MeLi.LiBr complex (1.50 mL, 2.2 M in Et₂O, 3.30 mmol) was added to 1-trimethylsilyloctadeca-1,3,5-triyne (1.06 g, 3.38 mmol) in THF (20 mL) at −78° C. in argon, and the resulting mixture was stirred for 30 min. Then ZnCl₂ (1.65 mL, 2 M in MeTHF, 3.30 mmol) was added at −78° C., and the resulting mixture was again stirred for 45 min. In another flask, n-butyl lithium (135 μL, 2.5 M in n-hexane, 0.34 mmol) was added to a suspension of Pd(dppf)Cl₂.DCM (138 mg, 0.17 mmol) in toluene (100 mL) at −78° C. under argon. The toluene solution containing 10-bromodeca-5,7,9-triyn-1-yl 4-methylbenzenesulfonate (10 mL, 1.69 mmol) and zinc acetylide solution were simultaneously added at this temperature, and the flask was shielded from light with aluminum foil. The mixture was stirred for 24 h at room temperature. The dark mixture was then diluted with Et₂O, washed three times with saturated NH₄Cl solution and once with saturated NaCl solution. The organic phase was dried over Na₂SO₄ and concentrated in vacuum to a volume of approximately 5 mL. Column chromatography (silica gel; gradient of eluent: from n-pentane/DCM 2:1 to n-pentane/DCM 1:1) yielded the product (130 mg, 14%) as a light brown oil.

NMR (400 MHz, CDCl₃) δ 7.79 (d, J=7.9 Hz, 2H), 7.35 (d, J=7.9 Hz, 2H), 4.05 (t, J=6.1 Hz, 2H), 2.46 (s, 3H), 2.34-2.30 (m, 2H), 1.63-1.51 (m, 4H), 1.39-1.35 (m, 2H), 1.26 (m, 18H), 0.88 (t, J=6.6 Hz, 3H). ¹³C NMR (101 MHz, CDCl₃) δ 144.90, 132.99, 129.91, 127.88, 82.11, 80.31, 69.51, 66.37, 65.63, 62.95, 62.65, 62.34, 62.18, 61.83, 61.38, 60.82, 60.31, 31.93, 29.63, 29.57, 29.42, 29.36, 29.00, 29.00, 28.85, 27.85, 23.84, 22.71, 21.68, 19.56, 18.92, 14.14.

### Preparation of Further Coatings

### Example 14 (Preparation and Transfer of Monomer Films to Solid Substrates)

Transfer of the monomer film from the air-water interface to a silicon wafer was achieved by the Langmuir-Blodgett technique using a computer-interfaced polytetrafluoroethylene Langmuir trough equipped with two barriers and a surface pressure microbalance with a filter paper Wilhelmy plate. Silicon or silicon dioxide substrates were cleaned in hot acidic piranha solution (1 part v/v 30 wt. % H₂O₂: 3 parts v/v concentrated H₂SO₄) for 20 minutes, sapphire substrates were cleaned in hot basic piranha solution (1 part v/v 30 wt. % H₂O₂: 3 parts v/v NH₃ (aq)) for 20 minutes, poly(ethylene terephthalate) (PET) substrates and tin substrates were cleaned by oxygen plasma treatment for 10 minutes, iron substrates were polished and sonicated. Tweezers attached to a mechanical arm were placed vertically above the Langmuir trough. Held by the tweezers, the substrates (silicon wafers with a native layer of silicon dioxide, sapphire substrates, PET substrates, iron substrates or tin substrates) were immersed in the subphase and the air-water interface was thoroughly cleaned before spreading of the molecular precursor. The film formation of the monomer methyl octacosa-5,7,9,11,13,15-hexaynoate at the air-water interface was achieved by spreading a dilute chloroform stock solution (c=1 mmol/L) on the surface of Millipore water in a polytetrafluoroethylene Langmuir trough equipped with two barriers and a surface pressure microbalance with a filter paper Wilhelmy plate was employed. Equilibration for 15 min allowed for the evaporation of the organic solvent. Compression of the film with a constant compression rate to a surface pressure of 8 mN/m led to the formation of a film comprising densely aggregated precursor molecules. The silicon wafer substrate was then slowly removed from the air-water interface by retreating the vertically aligned mechanical arm with a speed of 1.2 mm/min while keeping the surface pressure constant.

### Example 15 (Coating Layer Preparation on a Solid Substrate)

Monomer films of the precursor molecule methyl octacosa-5,7,9,11,13,15-hexaynoate were obtained by transfer from the air-water interface as described in Example 14 above. After removing the substrate from the Langmuir trough, the carbonization of the monomer films of the molecular precursors on the silicon dioxide substrate, on the sapphire substrate, on the PET substrate, on the tin substrate, and on the iron was achieved by UV irradiation for 40 min using a 250 W Ga-doped low-pressure Hg lamp (UV-Light Technology, Birmingham, United Kingdom), placed 20 cm away from the substrate. In this way, coatings on a silicon dioxide substrate, on a sapphire substrate, on a PET substrate, on a tin substrate, and on an iron substrate were obtained from the film of methyl octacosa-5,7,9,11,13,15-hexaynoate on the substrate.

### Analysis of the Properties of Coatings on Substrates

### Example 16 (UV-Vis Analysis of the Coatings on Sapphire)

UV-Vis absorption spectra of a monolayer film of methyl octacosa-5,7,9,11,13,15-hexaynoate monomers on a sapphire substrate prepared according to Example 14 and of a coating layer obtained by irradiation of a monolayer film of methyl octacosa-5,7,9,11,13,15-hexaynoate on a sapphire substrate prepared according to Example 15 were measured using a JASCO V-670 spectrometer at a scan speed of 400 nm/min in a measurement range of 200 to 800 nm. In each case, the baseline of the respective substrate used was recorded before transfer. The spectra are depicted in FIG. 7. The spectrum of the monolayer film of methyl octacosa-5,7,9,11,13,15-hexaynoate (dashed line in FIG. 7) shows absorption bands typical of oligoyne moieties between 250 and 300 nm. These peaks are absent from the spectrum of the coating layer obtained by irradiation of a monolayer film of methyl octacosa-5,7,9,11,13,15-hexaynoate on the sapphire substrate (dotted line in FIG. 7) that shows a broad and featureless absorption consistent with a reaction of the oligoyne moieties.

### Example 17 (Determination of Oxygen Transmission Rates on Arylite Films with a Coating)

Samples of Arylite® (a poly(arylate), copolymer of fluorene bisphenol-co-phthalic chloride) foils with a coating obtained by irradiation of a film of methyl octacosa-5,7,9,11,13,15-hexaynoate monomers were prepared analogously to the procedure described in Example 15. Oxygen transmission rates for Arylite® foils (100 μm thick) with a coating obtained by irradiation of a film of methyl octacosa-5,7,9,11,13,15-hexaynoate were determined with an oxygen permeation analyzer (Systech Instruments Model 8001) consisting of two independent measurement cells. In addition, oxygen transmission rates for Arylite® foils (100 μm thick) without a coating were determined as a reference. In each case, the film was held in place sandwiched with screws between metal plates and sealed at the rim of the measurement area with a sealant. As a calibration sample PET (thickness 12 μm) was used (OTR 115 cm³ m⁻² day⁻¹). The calibration measurement was conducted for 4 hours at 0% humidity. For each measurement, the bypass time was 40 minutes, the purge time 15 minutes. The measurement area was 5 cm² for both cells for each measurement. The top flow rate (100% oxygen) was adjusted to 20 cm³/mm and the bottom flow rate (100% nitrogen) was adjusted to 10 cm³/mm.

The traces for these substrates are depicted in FIG. 8. The Arylite® reference foils without a coating are depicted by triangles, the Arylite® foils with a coating are depicted by squares and circles. The measurements were conducted for more than 400 minutes. The Arylite® foils with a coating show a lower oxygen transmission rate with OTRs of 1976 cm³ m⁻² day⁻¹ and 1949 cm³ m⁻² day⁻¹ than the Arylite® foils without a coating with OTRs of 2254 cm³ m⁻² day⁻¹ and 2180 cm³ m⁻² day⁻¹, consistent with barrier properties imparted by the coating.

### Example 18 (Water Contact Angle Measurements of Coatings on Various Substrates)

Samples of PET, tin, silicon dioxide, or aluminum oxide substrates with a coating obtained by irradiation of a film of methyl octacosa-5,7,9,11,13,15-hexaynoate monomers were prepared according to Example 15. Water contact angles of these substrates with coatings were determined on a Krüss DAS 30 trop tensiometer at room temperature. For each measurement a volume of 7 μL Milli-Q (deionised and filtered) water was employed. Samples were used at room temperature under ambient conditions. Measurements were conducted in triplicates at 5 different spots on the sample. The results of the water contact angle measurements are compiled in Table 1.

TABLE 1
Water Contact Angles of various substrates

| | | Number | | Contact |
|---|---|---|---|---|
| Substrate | Pretreatment | of layers | Crosslinking | Angle/° |
| PET | — | — | — | 73 ± 2 |
| PET | O₂ Plasma-activated | — | — | 12 ± 3 |
| PET | O₂Plasma-activated | 1 | on solid substrate | 81 ± 4 |
| PET | O₂Plasma-activated | 5 | on solid substrate | 83 ± 1 |
| Sn | — | — | — | 81 ± 1 |
| Sn | O₂Plasma-activated | — | — | 12 ± 1 |
| Sn | O₂ Plasma-activated | 1 | on solid substrate | 39 ± 1 |
| Sn | O₂ Plasma-activated | 2 | on solid substrate | 85 ± 2 |
| Si/SiO₂ | — | — | — | 49 ± 6 |
| Si/SiO₂ | acidic Piranha | — | — | 30 ± 2 |
| Si/SiO₂ | acidic Piranha | 1 | on solid substrate | 83 ± 4 |
| Al₂O₃ | basic Piranha | — | — | 38 ± 1 |
| Al₂O₃ | basic Piranha | 1 | on solid substrate | 83 ± 5 |

In this table, larger angles correspond to a more hydrophobic surface. The table shows that the treated substrates without a coating have a more hydrophilic surface, while the substrates with a coating have a more hydrophobic coating.

### Example 19 (X-Ray Photoelectron Spectroscopy (XPS))

Samples of iron substrates with a coating obtained by irradiation of a film of methyl octacosa-5,7,9,11,13,15-hexaynoate monomers were prepared according to Example 15. X-Ray Photoelectron Spectroscopy (XPS) measurements were carried out on polished uncoated iron samples as well as on the iron substrates with a coating using a PHI VersaProbe II scanning XPS microprobe (Physical Instruments AG, Germany). Analysis was performed using a monochromatic Al Kα X-ray source of 24.8 W power with a beam size of 100 μm. The spherical capacitor analyser was set at 45° take-off angle with respect to the sample surface. The pass energy was 46.95 eV yielding a full width at half maximum of 0.91 eV for the Ag 3d 5/2 peak. Curve fitting was performed using the PHI Multipak software. The spectrum of the uncoated iron sample is depicted in FIG. 9. The atomic concentrations determined from this spectrum are as follows: C₁s 3.37%, 01s 40.83%, Fe2p3 55.80%. The spectrum of the iron sample with a coating is depicted in FIG. 10. The atomic concentrations determined from this spectrum are as follows: C₁s 42.86%, 01s 35.56%, Mg2p: 10.78, Si2p: 8.59, Fe2p3 1.35%, S2p: 0.86. Thus, the spectrum of the iron sample with a coating shows a significantly increased C₁s peak compared to the spectrum of the uncoated iron sample consistent with the presence of a coating on the iron sample.

1. A method for the manufacture of a coating comprising at least one coating layer on a solid substrate, said method comprising the steps of
a. providing monomers of the type R—(N)ₓ-(L)ₘ-(C≡C)ₙ-(L′)ₒ-(N′)_{y}—R′,
wherein
R is a head moiety,
R′ is a tail moiety,
(C≡C)ₙ is an oligoyne moiety,
L and L′ are linker moieties,
N and N′ independently are branched or unbranched optionally substituted C₁-C₂₅ alkyl moieties optionally containing 1 to 5 heteroatoms,
x, m, o, and y are independently 0 or 1,
n is 4 to 12,
and wherein said head moiety allows for an interaction with the surface of said solid substrate;
b. bringing said monomers into contact with said solid substrate wherein said interaction of said head moieties of said monomers with the surface of said solid substrate induces at least a part of said monomers to align in a defined manner thereby forming a film on said surface and bringing said oligoyne moieties of said monomers into close contact with each other;
c. inducing a reaction between oligoyne moieties by providing an external stimulus so as to at least partially cross-link said aligned monomers, thereby forming a coating layer on said solid substrate.

2. The method according to claim 1, characterized in that said head moiety R is selected from the group consisting of branched or unbranched alkyl, branched or unbranched haloalkyl, branched or unbranched alkenyl, branched or unbranched perfluoroalkyl, oligoethylenoxy, phenyl, tetrafluorophenyl, benzyl, aryl, C₁-C₄-alkyl-substituted aryl, in particular tolyl, heteroaryl, carboxy, ester, carboxamide, carbamoyl, oligopeptidyl, amine, halo, hydroxyl, mercapto, acryloyl, methacryloyl, styryl, isocyanate, sulfonyl hydroxide, C₁-C₄-alkyl-substituted arylsulfonyloxy, in particular toluene sulfonyloxy, phosphono or its derivatives, in particular diethylphosphono ((EtO)₂P(═O)—), phosphate or its derivatives, oxiranyl, trihalosilyl, and trialkoxysilyl.

3. The method according to claim 1 or 2, characterized in that said tail moiety R′ is selected from the group consisting of —H, branched or unbranched alkyl, branched or unbranched haloalkyl, branched or unbranched alkenyl, branched or unbranched perfluoroalkyl, oligoethylenoxy, phenyl, tetrafluorophenyl, benzyl, aryl, C₁-C₄-alkyl-substituted aryl, in particular tolyl, heteroaryl, carboxy, ester, carboxamide, carbamoyl, oligopeptidyl, amine, halo, hydroxyl, mercapto, acryloyl, methacryloyl, styryl, isocyanate, sulfonyl hydroxide, C₁-C₄-alkyl-substituted arylsulfonyloxy, in particular toluene sulfonyloxy, phosphono or its derivatives, in particular diethylphosphono ((EtO)₂P(═O)—), phosphate or its derivatives, oxiranyl, trialkylsilyl, trimethylsilyl, triethylsilyl, triisopropylsilyl, trihalosilyl, and trialkoxysilyl.

4. The method according to any of the preceding claims, characterized in that said linker components L and/or L′ are independently selected from the group consisting of methylene, ethylene, propylene, butylene, pentylene.

5. The method according to any of the preceding claims, characterized in that said tail moiety R′ allows for an interaction with the surface of a solid substrate of the same or a different material.

6. The method according to any of the preceding claims characterized in that said head moiety R and said tail moiety R′ are identical.

7. The method according to any of the preceding claims characterized in that said monomers are brought into contact with said solid substrate in solution in a solvent that wets the surface of said solid substrate.

8. The method according to claim 7 characterized in that said solution is brought into contact with said surface by painting, spraying, coating, dipping, immersion and/or casting.

9. The method according to any of the preceding claims characterized in that said interaction of said head moiety R of said monomers with said surface of said solid substrate is specific binding.

10. The method according to claim 9 characterized in that said specific binding allows for reversible and/or dynamic bond formation between said head moiety R and said surface of said substrate at room temperature.

11. The method according to claim 9 or 10 characterized in that said specific binding allows for the formation of covalent or non-covalent bonds between said head moieties R and said surface using said head moieties R of said monomers as ligands that have an affinity to a matching receptor site on said surface of said solid substrate.

12. The method according to claim 10 or 11 characterized in that the strength of said bonds of said specific binding is from 5 kJ/mol to 460 kJ/mol, particularly from 10 kJ/mol to 200 kJ/mol, more particularly from 10 kJ/mol to 100 kJ/mol.

13. The method according to any of the preceding claims characterized in that at least part of said monomers align such on said surface that a diffractogram measured in the plane of said film displays at least a first-order reflection.

14. The method according to any of the preceding claims characterized in that at least part of said monomers align such on said surface that the centers of gravity of said oligoyne moieties of said monomers are on a regular lattice within the immediate surroundings of a monomer.

15. The method according to claim 14 characterized in that said immediate surroundings of a monomer are within a radius of at least 0.5 nm, in particular at least 1 nm, more particularly at least 2 nm or at least 3 nm, from the center of gravity of the oligoyne moiety of that monomer.

16. The method according to any of the preceding claims characterized in that said close contact of said oligoyne moieties of said monomers is van-der-Waals contact.

17. The method according to any of the preceding claims characterized in that said head moieties R of said monomers are in contact with said surface of said solid substrate.

18. The method according to any of the preceding claims characterized in that said oligoyne moieties of said monomers are substantially devoid of contact with said surface of said solid substrate.

19. The method according to any of the preceding claims characterized in that each monomer has a long axis defined as the axis through the two carbon atoms of said oligoyne moiety that are farthest apart from each other and that said monomers are oriented with their respective long axes standing up from said surface of said solid substrate.

20. The method according to any of the preceding claims characterized in that said film on said surface has a thickness of from 0.1 to 500 nm, particularly from 0.1 to 250 nm, more particularly from 0.1 to 100 nm or from 0.2 to 50 nm or from 0.3 to 30 nm or from 0.5 to 10 nm.

21. The method according to any of the preceding claims characterized in that said external stimulus is heat, electromagnetic irradiation, and/or a chemical radical initiator.

22. The method according to any of the preceding claims characterized in that said external stimulus is UV irradiation.

23. The method according to any of the preceding claims characterized in that said reaction between oligoyne moieties is a carbonization reaction.

24. The method according to any of the preceding claims characterized in that said reaction between oligoyne moieties is induced and/or conducted at a temperature from 25 to 200° C., in particular from 25 to 100° C., more particularly from 25 to 50° C.

25. The method according to any of the preceding claims characterized in that said solid substrate is selected from the group consisting of silicon dioxide, glass, quartz, aluminum oxide, in particular sapphire, indium tin oxide, ceramics, mica, brass, non-noble metals such as aluminum, steel, iron, tin, solder, titanium, magnesium, zinc, chrome, copper, nickel, silicon, cobalt, tantalum, zirconium and oxides and chalcogenides thereof, noble metals such as silver, gold, platinum, palladium, osmium, and alloys thereof, silver oxide, polymers such as epoxy resins, polyesters, poly(ethylene terephthalate), poly(ethylene naphthalate), poly(lactic acid), polyamides, polyurethanes, poly(vinylic) polymers, poly(vinyl alcohol), poly(vinyl actate), poly(vinylidene chloride), polyolefins, dienic polymers, poly(isoprene), poly(methacrylate)s, and poly(acrylate)s.

26. The method according to any of the preceding claims characterized in that said coating layer on said solid substrate has a thickness of from 0.1 to 500 nm, particularly from 0.1 to 250 nm, more particularly from 0.1 to 100 nm or from 0.2 to 50 nm or from 0.3 to 30 nm or from 0.5 to 10 nm.

27. The method according to any of the preceding claims characterized in that said coating layer on said solid substrate comprises an atomically dense carbon layer.

28. The method according to any of the preceding claims characterized in that in an additional step before inducing said reaction between oligoyne moieties, a layer of an additional solid substrate is deposited on said film.

29. The method according to any of claims 1 to 27 characterized in that in an additional step after inducing said reaction between oligoyne moieties, a layer of an additional solid substrate is deposited on said coating layer.

30. Coating obtainable by a method according to any of claims 1 to 29.

31. The coating of claim 30 characterized in that said coating has wear-resistant properties, anti-corrosive properties, protein-repellent properties, hydrophobic properties and/or oleophobic properties.

32. Use of a coating according to claim 30 or 31 to control the wettability and/or to increase the corrosion resistance of components in machine building and/or precision mechanics.

33. A solid substrate comprising a coating according to claim 30 or 31.

34. Use of the solid substrate according to claim 33 as a barrier layer in food packaging, pharmaceutical packaging, and/or encapsulation of electronic devices.
